(19) United States
(12) Patent Application Publication
(10) Pub. No.: US 2026/0165542 A1
(43) Pub. Date: Jun. 18, 2026

(54) AUTONOMOUS SURFACE CLEANER WITH ANCHORING SUCTION MEMBER

(71) Applicant: Omachron Intellectual Property Inc., Hampton (CA)

(72) Inventors: Wayne Ernest Conrad, Hampton (CA); Stafford Conrad, Hampton (CA); Nina Conrad, Hampton (CA)

(21) Appl. No.: 19/376,485

(22) Filed: Oct. 31, 2025

Related U.S. Application Data
(60) Provisional application No. 63/733,601, filed on Dec. 13, 2024.

(51) Int. Cl. A47L 9/00; A47L 7/02; A47L 9/04; A47L 9/06; A47L 9/28; B25J 11/00; B25J 15/06

(52) U.S. Cl. CPC A47L 9/009; A47L 7/02; A47L 9/0477; A47L 9/0606; A47L 9/2836; B25J 11/0085; B25J 15/0616

(57) ABSTRACT

A robotic surface cleaner includes a cleaning member and at least one suction member. The robotic surface cleaner can move autonomously between different regions of the underlying surface to be cleaned. The suction member can be adjusted between an anchor condition in which the suction member is secured to the surface and a release condition in which the suction member is disengaged from the underlying surface. In the anchor condition, the suction member can maintain contact between the cleaning member and the underlying surface being cleaned to ensure the cleaning member remains in contact with the underlying surface while performing a cleaning action. The suction member may also allow the cleaning member to clean the underlying surface more vigorously, for instance to clean soiled or stained surface regions.

### CROSS-REFERENCE TO RELATED APPLICATION

This application claims benefit of U.S. Provisional Patent Application No. 63/733,601 filed on Dec. 13, 2024 entitled “MOBILE LOAD CARRYING SYSTEM”. The content of U.S. 63/733,601 is incorporated herein by reference in its entirety.

### FIELD

This application relates generally to surface cleaners, and in particular self-propelled surface cleaners and cleaning methods using a self-propelled surface cleaner.

### INTRODUCTION

The following is not an admission that anything discussed below is part of the prior art or part of the common general knowledge of a person skilled in the art.

Various types of robotic or autonomous surface cleaner are known. A robotic surface cleaner can include a cleaning member for extracting or loosening dirt from a surface so that the dirt can be more easily collected by the surface cleaner. The cleaning member can be a rotatable brushing member that may be referred to as a brush roll or brush bar. The brushing member can include bristles, wire, or other filaments extending therefrom that sweep, beat, or otherwise agitate dirt when the brushing member is rotated.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with one aspect of this disclosure, which may be used alone or in combination with any other aspect, there is provided a robotic surface cleaner that includes at least one suction member to maintain contact between a cleaning member of the surface cleaner and a surface being cleaned. The suction member(s) can ensure that the cleaning member remains in contact with the underlying surface while performing a cleaning action. The suction member(s) may also allow the cleaning member to clean the underlying surface more vigorously, for instance to clean heavily soiled or stained surface regions.

In accordance with this aspect, there is provided a robotic surface cleaner comprising: a mobile base that is autonomously movable along an underneath surface; at least one cleaning member located on the underside of the base; and at least one suction member attached to the base, each suction member being adjustable between an anchor condition and a release condition, in the anchor condition the suction member engages the surface underneath the base and a suction force secures the suction member to the surface and maintains the cleaning member in position to contact the surface, and in the release condition the mobile base is movable along the underneath surface.

The at least one cleaning member can be located at an inward portion of the base and the at least one suction member can be positioned at an outer portion of the base that is outward from the inward portion.

The at least one suction member can include a plurality of suction members arranged along the periphery of the base.

The at least one suction member can include at least three suction members.

Each suction member can be individually controllable to adjust the condition of the suction member.

Each suction member can be individually controllable to adjust the suction force applied by that suction member in the anchor condition.

The surface cleaner can be operable in an anchored cleaning mode in which the at least one cleaning member is operable to clean the surface while at least one of the suction members is secured to the surface in the anchor condition.

The surface cleaner can be operable in a mobile cleaning mode in which at least one cleaning member is operable to clean the surface while the base moves along the surface.

The motion of the cleaning member can drive the base along the surface.

The surface cleaner can include at least one floor engaging member mounted to the underside of the base, where the floor engaging member is operable to drive motion of the base along the surface.

At least one of the suction members can be maintained in the release condition while the surface cleaner is operating in the mobile cleaning mode.

At least one of the suction members can be maintained in the anchor condition while the surface cleaner is operating in the mobile cleaning mode.

The surface cleaner can include at least one floor engaging member mounted to the underside of the base, where the floor engaging member is operable to provide a driving force for the base.

The at least one cleaning member can include at least one brush.

The at least one brush can be rotatable.

The at least one cleaning member can include a cleaning pad.

The surface cleaner can include a suction motor operable to establish the suction force between at least one of the suction members and the surface.

The surface cleaner can include a dirt inlet fluidly coupled to an airflow pathway; and a first fan provided in the airflow pathway; where the suction motor is drivingly connected to the first fan.

The surface cleaner can include an inflatable cuff surrounding a carpet cleaning suction member of the at least one suction member, where the surface cleaner is operable in a carpet cleaning mode in which the inflatable cuff is in an inflated condition and the at least one carpet cleaning suction member is in the anchor condition.

In accordance with another aspect of this disclosure, which may be used alone or in combination with any other aspect, there is provided a robotic surface cleaner that includes at least one suction member and a movable cleaning member. The cleaning member can provide a driving force to drive motion of the robotic surface cleaner. The driving force can propel the surface cleaner when operating in a mobile cleaning mode. The suction member can be controlled to increase the downward force on the surface cleaner to increase or maintain the contact between the cleaning member and the surface being cleaned.

In accordance with this aspect, there is provided a robotic surface cleaner comprising: a mobile base that is autonomously movable along an underneath surface; at least one cleaning member located on the underside of the base; and a first suction member attached to the base, the first suction member being adjustable between an anchor condition and a release condition, in the anchor condition the first suction member engages the surface underneath the base and a suction force secures the suction member to the surface and maintains the cleaning member in position to contact the surface, and in the release condition the mobile base is movable along the underneath surface; wherein the surface cleaner is operable in at least one mobile mode in which motion of the cleaning member provides a driving force for the base.

In a mobile cleaning mode, the suction force applied by the suction members can be reduced.

In a mobile cleaning mode, the first suction member can be maintained in the release condition.

In the mobile cleaning mode, the first suction member can be maintained in the anchor condition thereby enabling the base to pivot relative to the surface.

In a mobile cleaning mode, the first suction member can be maintained in the anchor condition and the base can be rotatable about a rotation axis defined by the at least one suction member.

In the mobile cleaning mode, the base can be rotatable about the rotation axis while maintained in a fixed anchor position along the surface.

In a robot translation mode, the first suction member can be maintained in the release condition thereby enabling the base to translate relative to the surface.

The at least one cleaning member can be located at an inward portion of the base and the at least one suction member can be positioned at an outer portion of the base that is outward from the inward portion.

The surface cleaner can include a plurality of additional suction members arranged along the periphery of the base.

At least two additional suction members can be provided.

The surface cleaner can be operable in an anchored cleaning mode in which at least one cleaning member is movable relative to the surface to thereby clean the surface while at least one of the suction members is secured to the surface in the anchor condition.

The surface cleaner can include at least one floor engaging member mounted to the underside of the base, where the floor engaging member can be operable to drive motion of the base along the surface.

The surface cleaner can be operable in a forward motion mode and a reverse motion mode, and the at least one cleaning member can rotate in opposite directions in the forward motion mode and the reverse motion mode.

The least one cleaning member can include a plurality of cleaning members including a first cleaning member and a second cleaning member, and the surface cleaner can be operable in a turning mode in which the first cleaning member and second cleaning member rotate in opposite directions whereby a turning force is provided which adjusts a direction of motion of the base.

The at least one suction member can include a single central suction member enabling the surface cleaner to rotate about a central axis of the base while the central suction member is in the anchor condition.

In accordance with another aspect of this disclosure, which may be used alone or in combination with any other aspect, there is provided a robotic surface cleaner with a cleaning member and a plurality of suction members attached to the base of the surface cleaner. Each of the suction members are selectively adjustable to an anchor condition in which a suction force secures the suction member to the surface and maintains the cleaning member in position to contact the surface. This can provide an added downward force to assist with cleaning of the underlying surface.

In accordance with this aspect, there is provided a robotic surface cleaner comprising: a mobile base that is movable along an underneath surface; at least one cleaning member positioned on the underside of the base; and a plurality of suction members attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface.

The at least one cleaning member can be located at an inward portion of the base and the suction members can be positioned at an outer portion of the base that is outward from the inward portion.

The plurality of suction members can be arranged along the periphery of the base.

The plurality of suction members can include at least three suction members.

The plurality of suction members can include at least one inward suction member positioned at an inward portion of the base relative to the at least one cleaning member.

The plurality of suction members can include at least one inward suction member positioned at an inward portion of the base relative to the at least one cleaning member and at least one outward suction member positioned at an outward portion of the base relative to the at least one cleaning member.

The at least one cleaning member can include at least one brush.

The at least one brush can be rotatable.

The at least one cleaning member can include a cleaning pad.

In accordance with another aspect of this disclosure, which may be used alone or in combination with any other aspect, there is provided a robotic surface cleaner that includes a central suction member. The central suction member can be controlled to maintain contact between a cleaning member of the surface cleaner and a surface being cleaned while permitting the robotic surface cleaner to rotate about a rotational axis defined by the central suction member.

In accordance with this aspect, there is provided a robotic surface cleaner comprising: a mobile base that is movable along an underneath surface; at least one cleaning member positioned on the underside of the base; and a central suction member attached to a central portion of the base, the central suction member being adjustable between an anchor condition and a release condition, in the anchor condition the central suction member engages the surface underneath the base and a suction force is applied to secure the central suction member to the surface and maintain the cleaning member in position to contact the surface, and in the release condition the central suction member is disengaged from the surface; wherein the base is rotatable about a central rotation axis defined by the central suction member while the central suction members is maintained in the anchor condition.

The surface cleaner can be operable to adjust the suction force applied by the central suction member while in the anchor condition.

The surface cleaner can include at least one additional outward suction member positioned at an outward portion of the base relative to the at least one cleaning member.

The surface cleaner can include at least one periphery suction member positioned at the periphery of the base.

The at least one periphery suction member can include at least 3 periphery suction members.

The surface cleaner can include at least one additional inward suction member positioned at an inward portion of the base relative to the at least one cleaning member.

The surface cleaner can include at least one inward suction member positioned at an inward portion of the base relative to the at least one cleaning member and at least one outward suction member positioned at an outward portion of the base relative to the at least one cleaning member.

The at least one cleaning member can include at least one brush.

The at least one brush can be rotatable.

The at least one cleaning member can include a cleaning pad.

In accordance with another aspect of this disclosure, which may be used alone or in combination with any other aspect, there is provided a method of cleaning a surface using a surface cleaner. The surface cleaner can clean a first surface region while maintained in a first position by a suction member secured to the underlying surface. The surface cleaner can then move to a second position and clean a second surface region while maintained in the second position by a suction member secured to the underlying surface. This method can allow the surface cleaner to perform enhanced cleaning of different regions of a surface as part of an iterative cleaning method and/or a spot cleaning operation.

In accordance with this aspect, there is provided a surface cleaning method comprising: operating a surface cleaner to clean a surface while the surface cleaner is maintained in a first position overlying the surface by at least one suction member; moving the surface cleaner to a second position overlying the surface; and operating the surface cleaner to clean the surface while the surface cleaner is maintained in the second position by the at least one suction member.

The method can include positioning the surface cleaner in the first position; securing the surface cleaner in the first position by using the at least one suction member to engage a surface underneath the surface cleaner and to apply a suction force to secure the at least one suction member to the surface.

The method can include disengaging the at least one suction member from the surface prior to moving the surface cleaner to the second position.

Operating the surface cleaner to clean the surface can include dispensing cleaning fluid onto the surface.

Operating the surface cleaner to clean the surface can include operating a surface cleaning member to agitate the surface.

The method can include rotating the surface cleaner while the surface cleaner is maintained in the first position.

At least one of the suction members can remain secured to the surface while the surface cleaner is moved to the second position.

The method can include repeating, for an entire surface area to be cleaned, the steps of: moving the surface cleaner to an additional position overlying the surface; and operating the surface cleaner to clean the surface while the surface cleaner is maintained in the additional position by the at least one suction member

The method can include identifying the second position as an anchor position within a surface area to be cleaned; and moving the surface cleaner to the second position in response to identifying the anchor position.

The method can include identifying an anchor position by: detecting an unclean surface region; and defining the anchor position such that the surface cleaner overlies at least a portion of the unclean surface region when moved to the anchor position.

In accordance with another aspect of this disclosure, which may be used alone or in combination with any other aspect, there is provided a robotic surface cleaner that includes a suction member and a movable cleaning member. The suction member can be controlled to maintain contact between the cleaning member and a surface being cleaned. The cleaning member can move along the underlying surface, e.g. translate such as being on an extendable arm or along a track, to thereby clean the surface while the suction member is secured to the surface in the anchor condition.

In accordance with this aspect, there is provided a robotic surface cleaner comprising: a mobile base that is movable along an underneath surface; at least one cleaning member positioned on the underside of the base; and at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; wherein the surface cleaner is operable in an anchored cleaning mode in which a translatable cleaning member of the at least one cleaning member is movable relative to the surface to thereby clean the surface while at least one of the suction members is secured to the surface in the anchor condition.

The at least one suction member can include a first set of suction members and a second set of suction members; and when the surface cleaner is in the anchored cleaning mode the second set of suction members can be in the release condition and can be movable relative to the surface while the first set of suction members are secured to the surface in the anchor condition.

The surface cleaner can be operable in a repositioning mode; and when the surface cleaner is in the repositioning mode the second set of suction members can be secured to the surface in the anchor condition and the first set of suction members can be in the release condition and can be movable relative to the surface to reposition the first set of suction members.

The surface cleaner can be configured to operate sequentially in the anchor cleaning mode and the repositioning mode.

The surface cleaner can be configured to iteratively repeat the anchor cleaning mode and the repositioning mode while cleaning a surface region.

The translatable cleaning member can be in a fixed position on the underside of the mobile base, and in the anchored cleaning mode the cleaning member can be translated by motion of at least a portion of the mobile base along the surface.

Each suction member can be attached to the base by an extendable arm, where the extendable arm can be operable to extend in response to motion of the base while the suction member is in the anchor condition.

When the surface apparatus is in the anchored cleaning mode: the mobile base can be maintained in a fixed position by the at least one of the suction members secured to the surface in the anchor condition; and the cleaning member can be movable relative to the mobile base.

The at least one suction member can include a first set of suction members and a second set of suction members; and when the surface cleaner is in the anchored cleaning mode the second set of suction members can be in the release condition and the first set of suction members can be secured to the surface in the anchor condition.

The at least one suction member can include a first set of suction members and a second set of suction members; and when the surface cleaner is in the anchored cleaning mode the second set of suction members and the first set of suction members can be secured to the surface in the anchor condition.

Each set of suction members can include at least two suction members.

In accordance with another aspect of this disclosure, which may be used alone or in combination with any other aspect, there is provided a method of cleaning a surface using a surface cleaner in which the surface cleaner initially cleans an underlying surface region before applying a suction member to the underlying surface region. This can improve the contact between the suction member and the surface region and thus increase the strength of the suction force securing the suction member to the surface. The surface cleaner can then further clean the underlying surface region while secured to the surface by the suction member.

In accordance with this aspect, there is provided a surface cleaning method comprising: operating a surface cleaner to initially clean a first region of a surface underlying the surface cleaner while the surface cleaner is at a first position overlying the first region; securing the surface cleaner in the first position by applying at least one suction member to the surface within the first region; and operating the surface cleaner to clean the first region while the surface cleaner is maintained in the first position by the at least one suction member.

Initially cleaning the first region can include cleaning an anchor section of the first region; and the at least one suction member can be applied to the anchor section to secure the surface cleaner in the first position.

Operating a surface cleaner to initially clean the first region can include rotating the surface cleaner while the surface cleaner is in the first position.

The first region can be initially cleaned using suction.

The first region can be initially cleaned a cleaning member of the surface cleaner.

The method can include detecting an uneven surface portion; and selecting the first position to avoid positioning the surface cleaner on the uneven surface portion.

The method can include determining that the first position overlies an uneven surface portion; and applying a fluid to the uneven surface portion prior to applying the at least one suction member to the surface to improve the suction force applied by the at least one suction member.

The method can include applying a fluid to the first region prior to applying the at least one suction member to the surface to improve the suction force applied by the at least one suction member.

The method can include maintaining the surface cleaner in the first position using a suction motor to continuously apply a motorized suction force between the at least one suction member and the surface.

The method can include determining that the first position overlies an uneven surface portion; and maintaining the surface cleaner in the first position using a suction motor to continuously apply a motorized suction force between the at least one suction member and the uneven surface portion.

In accordance with another aspect of this disclosure, which may be used alone or in combination with any other aspect, there is provided a robotic surface cleaner that can perform spot cleaning operations in response to the detection of an unclean surface region. A stain detection signal can be generated when the unclean surface region is detected. The surface cleaner can move to the unclean surface region in response to receiving the stain detection signal in order to perform the spot cleaning operations.

In accordance with this aspect, there is provided a robotic surface cleaner comprising: a mobile base that is movable along an underneath surface; at least one cleaning member positioned on the underside of the base; and a controller operable to drive motion of the mobile base along the underneath surface, wherein the controller is configured to: receive a stain detection signal indicating an unclean surface region; in response to the stain detection signal, drive the mobile base to an anchor position such that the surface cleaner overlies at least a portion of the unclean surface region when moved to the anchor position; and operate the at least one cleaning member to clean the unclean surface region while the mobile base is in the anchor position.

The surface cleaner can include at least one suction member attached to the base, each suction member can be adjustable between an anchor condition and a release condition, in the anchor condition the suction member can engage the surface underneath the base and apply a suction force to secure the suction member to the surface and maintain the cleaning member in position to contact the surface, and in the release condition the suction member can be disengaged from the surface; the controller can be configured to operate the surface cleaner in a spot cleaning mode, in which at least one of the suction members is secured to the surface in the anchor condition while the at least one cleaning member is operated to clean the unclean surface region.

The surface cleaner can include a cleaning fluid dispenser, and the controller can be configured to operate the cleaning fluid dispenser to dispense cleaning fluid onto the unclean surface region prior to operating the at least one cleaning member to clean the unclean surface region.

The surface cleaner can include a sensor operable to detect the unclean surface region and to generate the stain detection signal in response to detecting the unclean surface region.

The stain detection signal can be received from a color sensor and/or an ultraviolet detector.

The stain detection signal can be received from a remote computing device in communication with the controller.

The stain detection signal can be user-generated.

The stain detection signal can be generated in response to image data captured by the remote computing device indicating the unclean surface region; and the stain detection signal can include stain coordinates for the unclean surface region, where the controller is operable to drive the mobile base to the anchor position based on the stain coordinates.

The stain coordinates can be defined based on relative base coordinates indicating a relative position of a surface cleaner base station to the image data captured by the remote computing device.

The stain detection signal can be received from a camera.

In accordance with another aspect of this disclosure, which may be used alone or in combination with any other aspect, there is provided a robotic surface cleaner that includes at least one suction member that is adjustable to an anchor condition in which the suction member engages the surface underneath the base and a suction force is applied to secure the suction member to the surface. The robotic surface cleaner also includes a suction member cleaning unit that is operable to clean each suction member. This can ensure that the surface engaging portion of the suction member is clean and provides a more secure seal to improve the suction force applied to secure the suction member to the surface.

In accordance with this aspect, there is provided a robotic surface cleaner comprising: a mobile base that is movable along an underneath surface; at least one cleaning member positioned on the underside of the base; at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; and a suction member cleaning unit operable to clean each suction member while that suction member is in the release condition.

The suction member cleaning unit can include a wiper operable to clean a lower surface of a corresponding suction member while that suction member is in the release condition.

The wiper can be intermittently cleanable.

The wiper can be cleanable at a surface cleaner base station.

The suction member can be cleanable onboard the surface cleaner.

The suction member can be cleanable while the surface cleaner is operational.

The suction member can be cleanable at a surface cleaner base station.

The suction member cleaning unit can include a cloth member operable to clean a lower surface of a corresponding suction member by travelling along the lower surface while that suction member is in the release condition.

The cloth member can be provided by a windable roll of cloth.

The cloth member can be provided by a continuous loop of cloth.

Cloth portions of the loop of cloth can be cleaned after travelling along the lower surface of the corresponding suction member.

In accordance with another aspect of this disclosure, which may be used alone or in combination with any other aspect, there is provided a robotic surface cleaner that includes at least one suction member that is adjustable to an anchor condition in which the suction member engages the surface underneath the base and a suction force is applied to secure the suction member to the surface. The robotic surface cleaner also includes a suction member cleaning unit with a roll of cleaning material usable to clean the suction members when not engaged with the underlying surface. This can ensure the suction member is clean and provides a more secure seal to improve the suction force applied to secure the suction member to the surface.

In accordance with this aspect, there is provided a robotic surface cleaner comprising: a mobile base that is movable along an underneath surface; at least one cleaning member positioned on the underside of the base; at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; and a suction member cleaning unit operable to clean each suction member while that suction member is in the release condition, wherein the suction member cleaning unit comprises a roll of cleaning material.

The roll of cleaning material can be reusable.

The roll of cleaning material can be cleanable onboard the surface cleaner.

The roll of cleaning material can be cleanable while the surface cleaner is operational.

The roll of cleaning material can be cleanable at a surface cleaner base station.

The roll of cleaning material can be a roll of disposable cleaning material.

In accordance with one aspect of this disclosure, which may be used alone or in combination with any other aspect, there is provided a robotic surface cleaner that includes a carpet cleaning suction member and an inflatable cuff that surrounds the carpet cleaning suction member. The surface cleaner can operate in a carpet cleaning mode in which the cuff is inflated and the carpet cleaning suction member engages an underlying surface. The cuff can provide an improved seal around the suction member when the underlying surface is an uneven surface such as carpet pile.

In accordance with this aspect, there is provided a robotic surface cleaner comprising: a mobile base that is movable along an underneath surface; at least one cleaning member positioned on the underside of the base; at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; and at least one inflatable cuff surrounding at least one carpet cleaning suction member; wherein the surface cleaner is operable in a carpet cleaning mode in which the inflatable cuff is in an inflated condition and the at least one carpet cleaning suction member is in the anchor condition.

The robotic surface cleaner can include a suction motor coupled to the at least one carpet cleaning suction member, where the suction motor can be operable to establish the suction force between the at least one carpet cleaning suction member and the surface when the surface cleaner is in the carpet cleaning mode.

In accordance with one aspect of this disclosure, which may be used alone or in combination with any other aspect, there is provided a robotic surface cleaner with an ultraviolet light source. The ultraviolet light source can direct ultraviolet light at a surface being cleaned in order to disinfect the surface.

In accordance with this aspect, there is provided a robotic surface cleaner comprising: a mobile base that is movable along an underneath surface; and a disinfectant member comprising an ultraviolet light source operable to disinfect the surface by directing ultraviolet light at the surface.

The robotic surface cleaner can include a dirt inlet fluidly coupled to an airflow pathway; and a motor and fan assembly coupled to the airflow pathway.

The robotic surface cleaner can include at least one cleaning member attached to the base, the cleaning member operable to clean the surface underneath the base.

The at least one cleaning member can include at least one brush.

The at least one brush can be rotatable.

The at least one cleaning member can include a cleaning pad.

The surface cleaner can include a cleaning fluid dispenser operable to dispense cleaning fluid onto the surface.

It will be appreciated by a person skilled in the art that a system, apparatus, or method disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1A is a side view of an example surface cleaner;

FIG. 1B is a perspective bottom view of the surface cleaner of FIG. 1A;

FIG. 1C is a sectional side view of the surface cleaner of FIG. 1A with a suction member in a first position;

FIG. 1D is another sectional side view of the surface cleaner of FIG. 1A with the suction member in a second position;

FIG. 1E is a perspective bottom view of another example surface cleaner;

FIG. 1F is a perspective bottom view of another example surface cleaner;

FIG. 1G is a perspective bottom view of another example surface cleaner;

FIG. 1H is a perspective bottom view of another example surface cleaner;

FIG. 1I is a perspective bottom view of another example surface cleaner;

FIG. 1J is a perspective bottom view of another example surface cleaner;

FIG. 2A is a side view of another example surface cleaner;

FIG. 2B is a perspective bottom view of the surface cleaner of FIG. 2A with a mobile section in a first position;

FIG. 2C is a perspective bottom view of the surface cleaner of FIG. 2A with the mobile section in a second position;

FIG. 2D is a sectional side view of the example surface cleaner of FIG. 2A in a first operational condition;

FIG. 2E is a sectional side view of the example surface cleaner of FIG. 2A in a second operational condition;

FIG. 2F is a sectional side view of the example surface cleaner of FIG. 2A in a third operational condition;

FIG. 2G is a sectional side view of the example surface cleaner of FIG. 2A in a fourth operational condition;

FIG. 2H is a sectional side view of the example surface cleaner of FIG. 2A in a fifth operational condition;

FIG. 3A is a side view of another example surface cleaner;

FIG. 3B is a perspective bottom view of the surface cleaner of FIG. 3A with a mobile section in a first position;

FIG. 3C is a perspective bottom view of the surface cleaner of FIG. 3A with the mobile section in a second position;

FIG. 3D is a sectional side view of the example surface cleaner of FIG. 3A in a first operational condition;

FIG. 3E is a sectional side view of the example surface cleaner of FIG. 3A in a second operational condition;

FIG. 3F is a sectional side view of the example surface cleaner of FIG. 3A in a third operational condition;

FIG. 3G is a sectional side view of the example surface cleaner of FIG. 3A in a fourth operational condition;

FIG. 3H is a sectional side view of the example surface cleaner of FIG. 3A in a fifth operational condition;

FIG. 4A is a perspective bottom view of another example surface cleaner with a mobile section in a first position;

FIG. 4B is a perspective bottom view of the example surface cleaner of FIG. 4A with the mobile section in a second position;

FIG. 5A is a perspective side view of another example surface cleaner;

FIG. 5B is a perspective bottom view of the example surface cleaner of FIG. 5A;

FIG. 5C is a sectional side view of the example surface cleaner of FIG. 5A in a first operational condition;

FIG. 5D is a sectional side view of the example surface cleaner of FIG. 5A in a second operational condition;

FIG. 5E is a sectional side view of the example surface cleaner of FIG. 5A in a third operational condition;

FIG. 5F is a sectional side view of the example surface cleaner of FIG. 5A in a fourth operational condition;

FIG. 6A is a perspective bottom view of another example surface cleaner;

FIG. 6B is a perspective bottom view of another example surface cleaner;

FIG. 7 is a perspective top view of another example surface cleaner;

FIG. 8A is a perspective side view of another example surface cleaner;

FIG. 8B is a perspective bottom view of the example surface cleaner of FIG. 8A;

FIG. 9 is a perspective bottom view of another example surface cleaner;

FIG. 10A is a perspective bottom view of another example surface cleaner;

FIG. 10B is a sectional side view of the example surface cleaner of FIG. 10A in a first operational condition;

FIG. 10C is a sectional side view of the example surface cleaner of FIG. 10A in a second operational condition;

FIG. 11A is a perspective bottom view of another example surface cleaner with a suction member cleaning unit in a first operational condition;

FIG. 11B is a perspective bottom view of the example surface cleaner of FIG. 11A with the suction member cleaning unit in a second operational condition; and

FIG. 11C is a sectional side view of the example surface cleaner of FIG. 11A.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Some elements herein may be identified by a part number, which is composed of a base number followed by an alphabetical or subscript-numerical suffix (e.g., 112a, or 112a1). Multiple elements herein may be identified by part numbers that share a base number in common and that differ by their suffixes (e.g., 112a, 112b, and 112c). All elements with a common base number may be referred to collectively or generically using the base number without a suffix (e.g., 112).

It should be noted that terms of degree such as “substantially”, “about”, and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

### General Description of an Autonomous Surface Cleaner

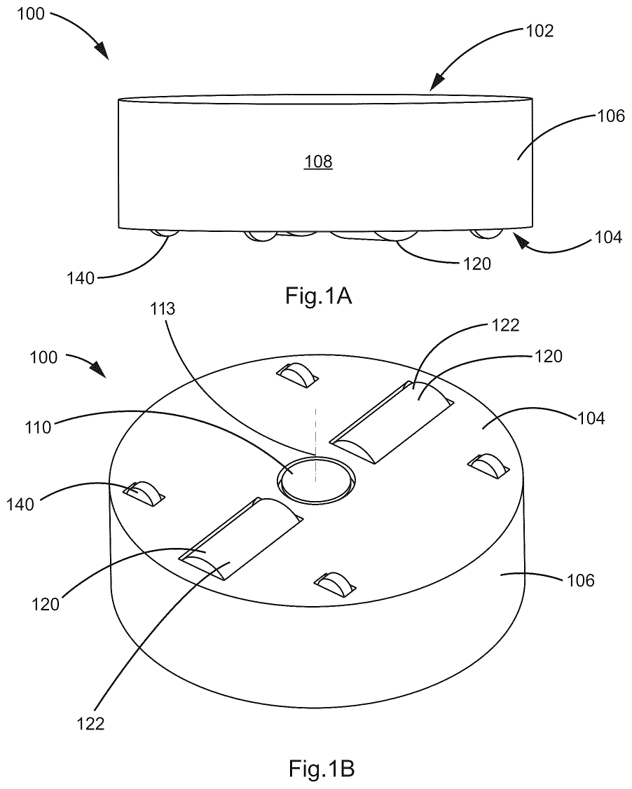

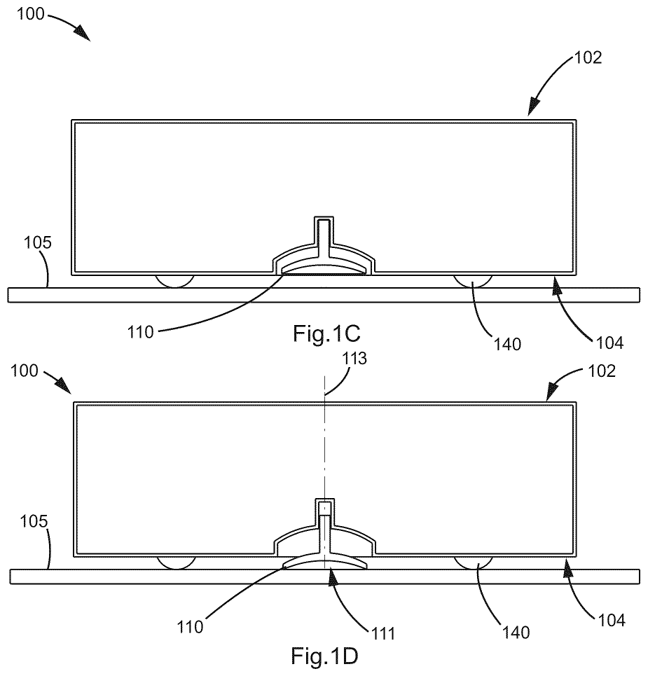

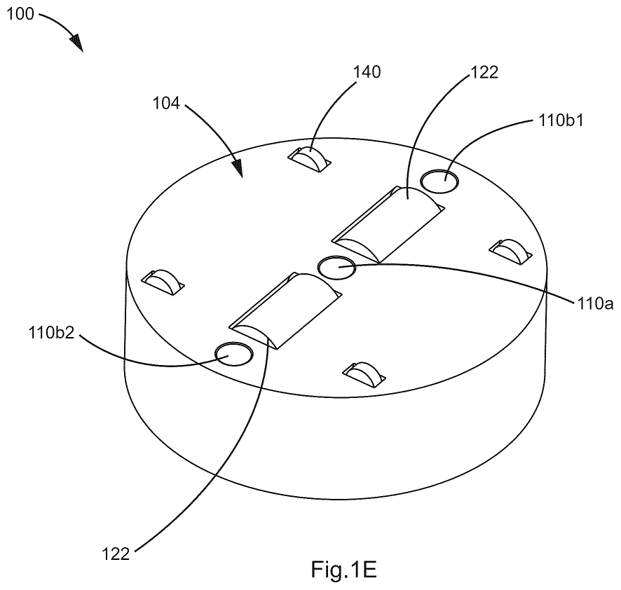

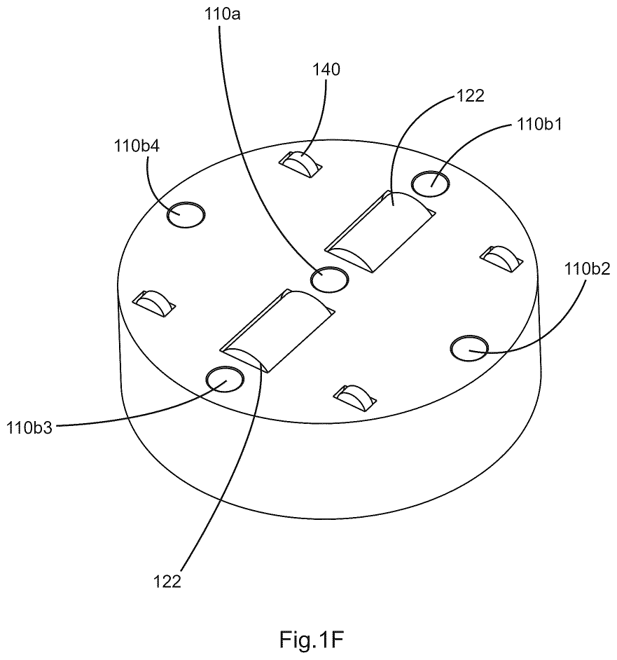

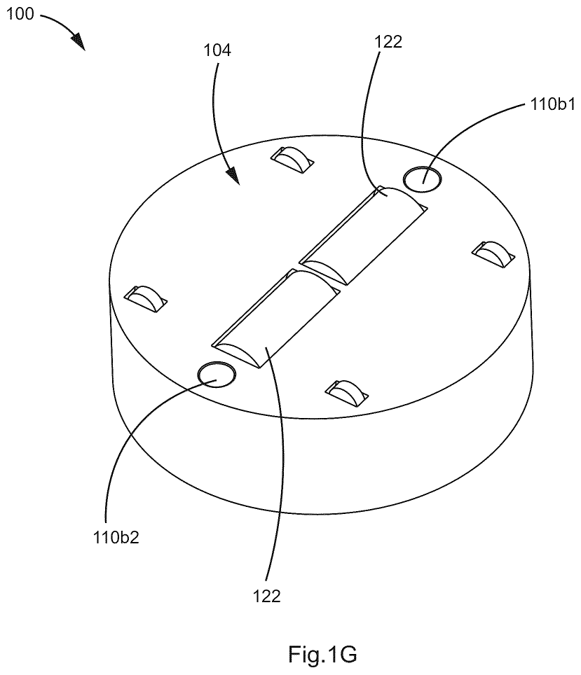

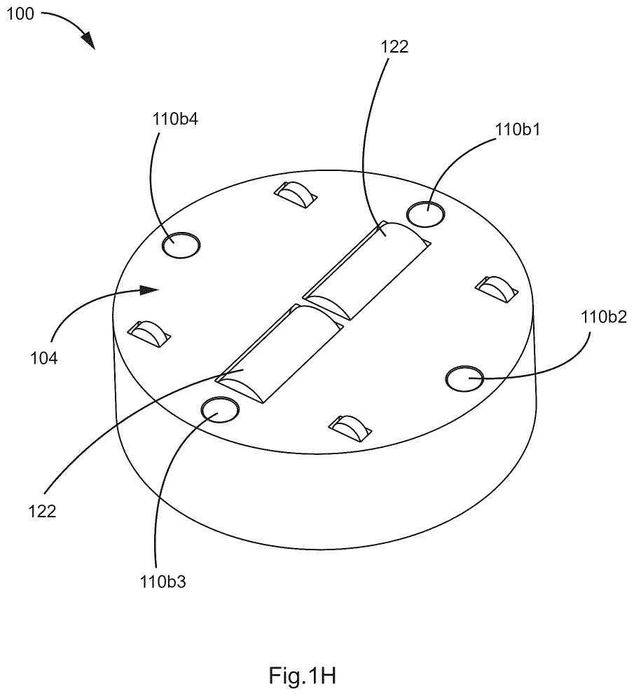

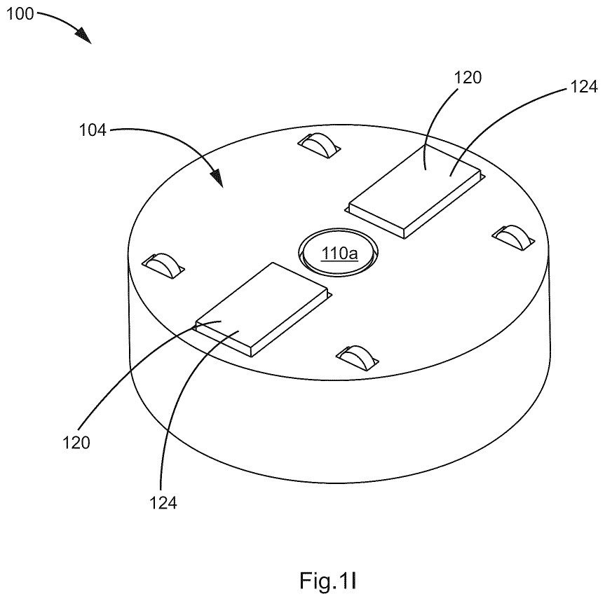

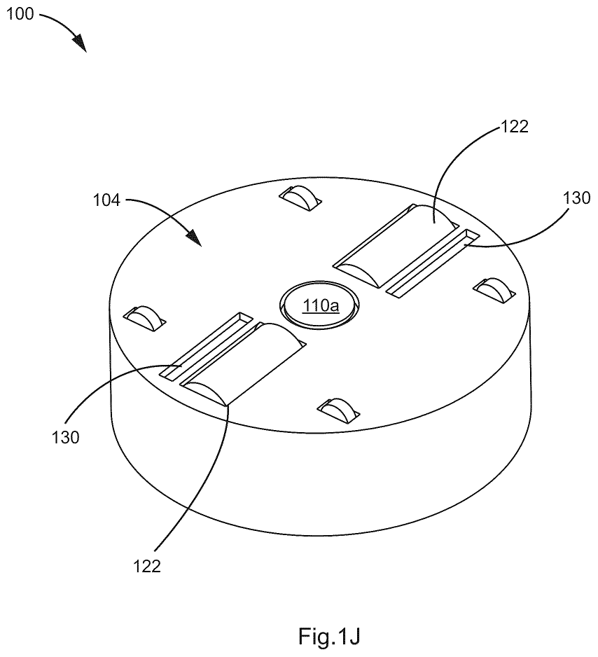

Referring to FIGS. 1A-1J, there is shown an example surface cleaner 100. In the illustrated example, the exemplified surface cleaner 100 is a robotic vacuum cleaner. However, the surface cleaner 100 can be any type of self-propelled surface cleaner including, for example, a robotic extractor, a robotic sweeper, or a robotic wet/dry type vacuum cleaner.

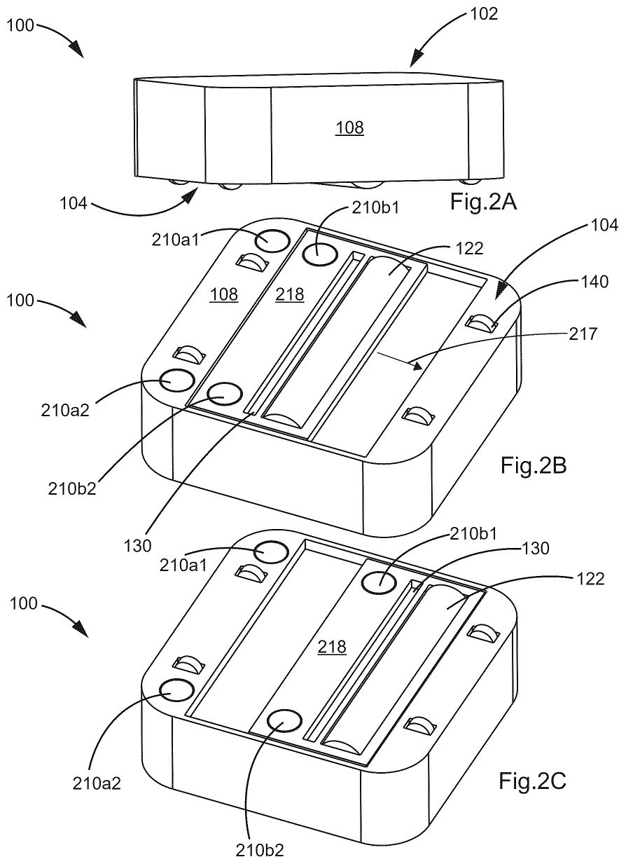

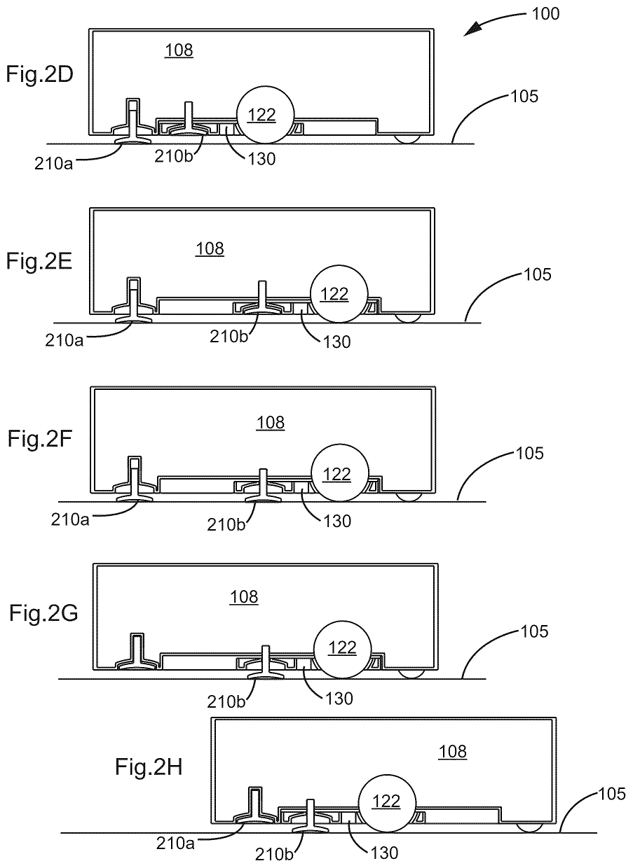

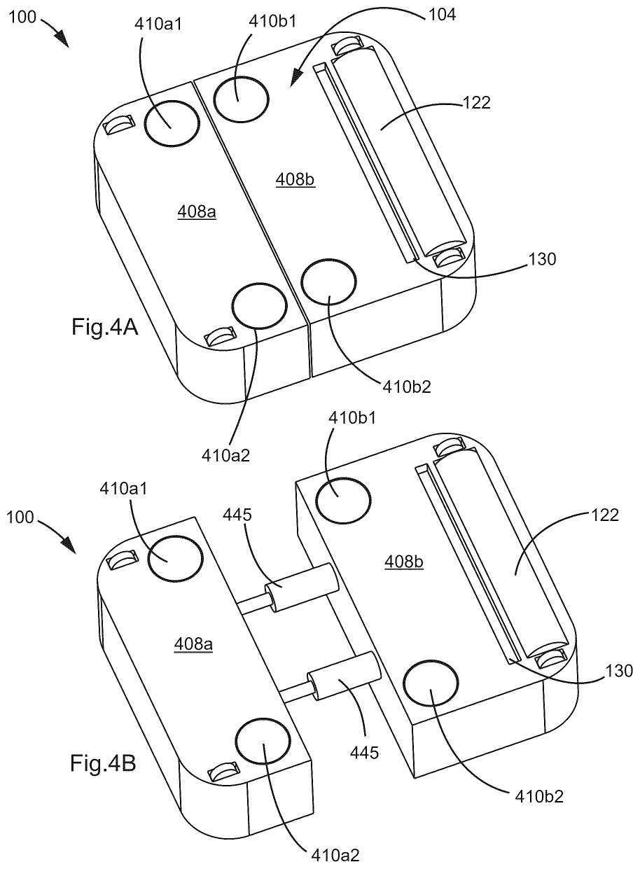

A robotic surface cleaner, such as the exemplified robotic vacuum cleaner may be of any shape and configuration. As exemplified in FIGS. 1A-1J, the robotic surface cleaner 100 may have a main body or base or housing 108 defined by a generally circular configuration, and comprising an upper end 102, a lower end 104 and peripheral side edge 106 extending between the upper and lower ends 102, 104. It will be appreciated that, in other examples, housing 108 may not have a circular configuration, but have any other suitable design or shape (such as a square or rectangular shape as shown in the example of FIG. 2A). It will also be appreciated that, in other example, the housing 108 may be provided by two or more housing portions connected to one another (see e.g. FIGS. 4A-4B).

The body 108 of the surface cleaner 100 can be movable along a surface underneath the surface cleaner 100. The surface cleaner 100 may move autonomously without requiring a user to drive motion of the surface cleaner 100. That is, the robotic surface cleaner 100 can be self-propelled along an underlying surface by one or more drive members.

Motion of the surface cleaner 100 may be controlled in various ways. For example, the surface cleaner 100 may move along a predefined motion pattern (e.g. to perform regular cleaning operations for a known or unknown region). The predefined motion pattern may be a default pattern (e.g. a default search/cleaning pattern) and/or a custom motion pattern (e.g. defined and/or learned for a particular area to be cleaned). Alternatively or in addition, the surface cleaner 100 may move in response to commands from a user device (e.g. in response to a user inputting a command to direct the motion of the surface cleaner 100). Alternatively or in addition, the vacuum surface 100 may move in response to the detection of an unclean surface region by onboard sensors and/or a remote device.

One or more floor engaging members may be provided, at a lower end 104 of the vacuum housing 108. The floor engaging members can support the vacuum housing 108 and enable the robotic surface cleaner 100 to move along a surface 105 requiring cleaning. At least one floor engaging member can be mounted to the underside of the base 104 of the vacuum housing. The floor engaging member can operate as a drive member and provide a driving force that is operable to drive motion of the base 104 along the surface 105.

In the example illustrated, the floor engaging members are provided by a plurality of wheels 140. The vacuum housing 108 can roll along the underlying surface 105 using the wheels 140. The wheels may be individual wheels, a laterally extending roller, caster wheels or the like. Alternatively, different types of floor engaging members may be used to support the vacuum housing 108, such as tank tracks or runners for example.

The robotic surface cleaner 100 can operate to clean the surface which is below the surface cleaner and which as exemplified, may be part of a floor that underlies the base 108. To contain dirt collected during cleaning operations, robotic surface cleaner 100 may be provided with a dirt bin located inside the robot housing 108 and may be referred to as a robotic vacuum cleaner 100. Optionally, robotic vacuum cleaner 100 can have one dirt bin for storing dirt collected by the robotic vacuum cleaner 100 while cleaning. It will be appreciated that a robotic vacuum cleaner 100 may have two or more dirt bins. The dirt bin may be of any configuration.

It will be appreciated that if the robotic surface cleaner is an extractor, hard surface wet cleaner or steam cleaner, then it may have a tank to supply a cleaning solution (e.g., water with or without a cleaning agent added) and, if it collects dirty liquid from a treated surface, it may have a dirty liquid collection reservoir.

The robotic vacuum cleaner 100 is also provided with a dirt inlet which may be of any design known in the robotic vacuum cleaner arts and may be provided at any location known in the robotic vacuum cleaner arts.

The robotic vacuum cleaner may also be provided with any floor cleaning member 120 known in the robotic vacuum cleaner arts. Referring to FIG. 1B, a cleaning member 120 can be located on a lower end 104 of the vacuum robot 100. The cleaning member 120 can be used to clean a surface, for example by sweeping dirt and debris from surfaces 105 during cleaning. It will be appreciated that if the robotic surface cleaner is an extractor, hard surface wet cleaner or steam cleaner, then the cleaning member may be a cleaning pad. The cleaning member 120 may be attached directly to the lower surface of the base 108 as shown in the example of FIG. 1B. Alternatively, a cleaning member 120 may be attached to the base 108 by an intermediate attachment member, such as an arm for example.

Alternatively or in addition, a cleaning member 120 may be attached to another portion of the base 108, such as the side of the base 108. The cleaning member 120 may extend laterally outward from the base 108 and/or downward below an underside 104 of the base 108.

As shown in FIG. 1B, the robotic surface cleaner 100 includes a cleaning member 120 in the form of one or more rotatable brushing members 122, which may also be referred to as a brush roll or brush bar. The one or more rotating brushes 122 can, by themselves using a mechanical sweeping action or in combination with an air flow, convey dirt through a dirt inlet into the dirt bin. The brushing member(s) 120 can be driven to rotate by a brush motor.

As shown, each brushing member 122 can include bristles, wire, other filaments such as a microfiber pad, flexible strips extending therefrom, or any other floor contacting member known in the art, for extracting, collecting, loosening or the like dirt from a surface. In operation, the brushing member 120 can be rotated so that the bristles brush, sweep, beat, travel across or otherwise agitate dirt from the surface so that the dirt can be more easily collected by the dirt inlet.

In various example, as provided in further detail herein, the robotic surface cleaner may also have a suction motor to draw, or assist in drawing, dirt and/or water into the robot dirt bin. In such examples, the robotic surface cleaner may be referred to as a robotic vacuum cleaner and the robotic vacuum cleaner 100 can include a dirty air inlet 130 arranged to capture air and dirt. If a suction motor is provided, then a clean air outlet may be provided. The clean air outlet may be located at any suitable location around the robot body 108 (e.g., top end 102, bottom end 104, or on a sidewall portion 106). Accordingly, an airflow path extends between the dirty air inlet (or sweeper) 130 and the clean air outlet with the suction motor positioned in the airflow path to generate a vacuum suction through the airflow path. Optionally, the suction motor may be positioned downstream of the dirt bin (e.g., a dirty air motor). The suction motor can be, for example, a fan-motor assembly including an electric motor and impeller blade(s).

If a suction motor is provided, then one or more pre-motor filters may be provided in the airflow path upstream of the suction motor. Pre-motor filters can be formed from any suitable physical, or porous filter media. For example, pre-motor filters may be one or more of a foam filter, a felt filter, a HEPA filter, or other physical filter media. Optionally, a pre-motor filter may include an electrostatic filter, or the like.

During operation of the robotic vacuum cleaner 100, the suction motor can be activated to drive airflow through the airflow path such that air is drawn through the dirty air inlet 130 and into the robot dirt bin. The airflow may continue through an air outlet of the dirt bin, and downstream through an air passage to the suction motor. Optionally, an additional pre-motor filter may be provided at the outlet of the dirt bin, to prevent airborne dirt from being carried downstream toward the suction motor. Air exiting the suction motor may continue through a second air passage and exit through a clean air outlet in the robot body 108.

In various example, as provided in further detail herein, the robotic surface cleaner may have one or more suction members 110. A suction member 110 may be operable in an anchored condition in which the suction member is secured to a surface 105 below the surface cleaner 100. The suction member(s) 110 may be usable to secure the surface cleaner 100 to the underlying surface and/or provide added downforce to improve the cleaning performance of the surface cleaner 100.

In examples of robotic surface cleaner 100 described herein below, the suction member(s), and/or floor engaging member(s), and/or cleaning member(s) can be driven automatically in response to control signals. Similarly, the operational modes and operating conditions of the surface cleaner 100, suction member(s) 110, and/or floor engaging member(s) 140, and/or cleaning member(s) 120 may be driven automatically in response to control signals. The operation of the surface cleaner 100, suction member(s) 110, floor engaging member(s) 140, cleaning member(s) 120 and other components of surface cleaner 100 can be controlled by a surface cleaner control system.

The robotic surface cleaner 100 can include an onboard control system that includes a processor, a volatile and non-volatile memory, at least one network interface, and optionally input/output devices. The network interface can be configured to establish communication with an external computing device such as a user device. The processor can be configured to control operations of the robotic surface cleaner 100, including adjusting suction members between anchored and release conditions, extending and retracting suction members, operating cleaning members, and optionally driving motion of the robotic surface cleaner 100, for instance using motorized wheels or movable/rotatable cleaning members. The processor can be configured to control various other operations of the robotic surface cleaner 100 such as the example operations described herein below.

The robotic surface cleaner 100 can also include one or more onboard energy storage members. The energy storage members may be any member, such as a battery or capacitor, that can store power that can be used to power the onboard components of the robotic surface cleaner 100, such as the processor, network interface, wheels, cleaning members, suction members, etc. The energy storage members can be provided in various forms, such as one or more batteries for example. Alternatively or in addition, the robotic surface cleaner 100 may include a power cord or power cord attachment member enabling the robotic surface cleaner 100 to connect to an external power source such as mains power.

The processor can receive control signals remotely from the user device and control operation of the various components of the robotic surface cleaner 100 in response to the received control signals. The processor can also transmit feedback signals to the user device, for instance indicating the status and/or position of the components of the robotic surface cleaner 100 (e.g. suction members in anchored or release conditions, suctions members in extended or retracted positions, energy storage member charge status, cleaning fluid levels, operational mode of the robotic surface cleaner 100, location of the robotic surface cleaner 100 etc.).

The robotic surface cleaner 100 can also include one or more onboard input devices. The input device(s) can provide a user interface that enables a user to input control signals directly to the robotic surface cleaner 100 to control operations of the robotic surface cleaner 100. The processor can control the operation of the various components of the robotic surface cleaner 100 in response to the control signals received through the input device(s). The user interface can be provided in many forms including for example buttons, switches, touchscreen interfaces, combinations thereof etc.

The robotic surface cleaner 100 can also include one or more onboard outputs devices. The output device(s) can provide a user with feedback on the status and operations of the robotic surface cleaner 100. For example, the output devices can provide visual, audio and/or tactile outputs to indicate the status and/or position of the components of the robotic surface cleaner 100 (e.g. suction members in anchored or release conditions, suctions members in extended or retracted positions, energy storage member status, cleaning fluid levels, operational mode of the robotic surface cleaner 100, location of the robotic surface cleaner 100 etc.).

The surface cleaner 100 can also include a communication interface enabling bidirectional data communication for the surface cleaner 100. For example, a user device can be connected to the robotic surface cleaner 100 via a network. The network may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

Alternatively or in addition, a user device and robotic surface cleaner 100 may establish a direct connection, e.g. using a wireless communication protocol such as Bluetooth for example.

A user device generally refers to a smartphone or tablet computer, but may also refer to desktop or laptop computers, as well as a wide variety of “smart” devices capable of data communication (e.g. wearable computing devices such as smartwatches, smart glasses, and/or smart clothing). The user device includes a processor, a volatile and non-volatile memory, at least one network interface, and input/output devices. User devices may be portable, and may at times be connected to a network or a portion thereof. In some examples, there may be multiple user devices.

A user device can have a plurality of software applications operating thereon. The plurality of software applications can include a vacuum cleaner control application usable to control operations of the surface cleaner 100. A user may interact with the vacuum cleaner control application to provide control inputs to direct the operations of the surface cleaner 100. The user device can transmit corresponding control signals to the surface cleaner 100 (e.g. via a network or direct wireless connection to the surface cleaner 100).

Surface Cleaner with One or More Suction Members

The following is a description of a robotic surface cleaner having one or more suction members. It will be appreciated that the features of the robotic surface cleaner having one or more suction members may be used alone or in combination with various other features of an autonomous surface cleaner described herein, such as a robotic surface cleaner operable in one or more operational modes, a robotic surface cleaner with a mobile cleaning section, a robotic surface cleaner operable with one or more stain detection sensors, a robotic surface cleaner operable with one or more fluid dispensers, a robotic surface cleaner operable with one or more disinfectant members, a robotic surface cleaner having a carpet cleaning suction member, a robotic surface cleaner having a suction member cleaning unit, and a surface cleaning method.

The suction members can be used to maintain contact between the robotic surface cleaner and the surface being cleaned. The following description contains various features which may be used individually or in any combination or sub-combination.

The robotic surface cleaner 100 can be provided with one or more suction members 110. Each suction member 110 can be selectively secured to an underlying surface 105 to secure at least a portion of the surface cleaner 100 to the surface 105.

Suction members 110 may provide a number of advantages for a robotic surface cleaner 100. For example, the suction member(s) 110 may help secure the surface cleaner 100 in a fixed position for spot cleaning operations and/or an iterative cleaning process. The suction member(s) 110 may also provide additional downforce to improve the cleaning performance of the surface cleaner 100 on the underlying surface 105.

Each suction member 110 can be adjusted between an anchor operating condition and a release operating condition. In the anchor operating condition, a suction force is applied to secure the suction member 110 to the surface. In the release operating condition, the suction force is released and the suction member can thereby be disengaged from the surface.

When a suction member 110 is in the anchor operating condition it can define an anchor location where the suction member 110 remains fixed. The robotic vacuum cleaner can perform cleaning operations with the suction member 110 maintained at the anchor location. This may ensure that the surface cleaner cleans a desired or specified surface location. This may also provide additional downforce to improve the effectiveness of the cleaning operation at the specified surface location.

The suction member 110 can subsequently be released. Optionally, a new anchor location can be defined using the same or another suction member 110. The robotic surface cleaner 100 can then perform further cleaning operations with a suction member 110 secured at this new anchor location. This process can be repeated to enable the robotic surface cleaner 100 to clean a surface in an incremental manner. The use of suction member(s) 110 may ensure that the surface cleaner 100 has sufficient leverage to clean heavily soiled or stained surface regions.

Optionally, a portion of the robotic surface cleaner 100 may be movable relative to the anchor location while the suction member 110 remains fixed. This may provide added flexibility for the surface cleaner 100 to perform cleaning operations for a larger area in the vicinity of the anchor location and/or with added downforce.

Referring now to FIGS. 1A-1D, shown therein is an example of a surface cleaner 100 that includes at least one suction member 110. The suction member 110 can be used to secure at least a portion of the surface cleaner 100 to an underlying surface, e.g., a floor. As shown in FIGS. 1A-1D, the surface cleaner 100 also includes at least one cleaning member 120 located on the underside of the base 104. In the example illustrated, a single central suction member 110 is attached to the underside 104 of the robot housing or body or base 108.

Optionally, the surface cleaner 100 can include a plurality of suction members 110 (see e.g. FIGS. 1E-1H). Each of the suction members 110 can extend below the underside of the base 104. The suction members 110 may be located on the underside of the base 104 as shown in the example illustrated.

Each suction member 110 can be adjusted between an anchor condition (see e.g. FIG. 1D) and a release condition (see e.g. FIG. 1C). In the anchor condition, the suction member 110 engages, e.g., the surface 105 underneath the base 104 of the body 108 (i.e, the surface on which the robotic surface cleaner 100 travels) and a suction force secures the suction member 110 to the surface 105. The suction force can prevent the suction member 110 from moving relative to the surface 105. The suction force also helps maintain the cleaning member(s) 120 in position to contact the surface 105 and perform cleaning operations thereon. It will be appreciated that, alternately or in addition, one or more suction members may be located exterior to (e.g., radially outwardly of) the body 108, such as on arms. In this way, the robotic surface cleaner may be secured in position with all of the underside of the body 108 exposed to the floor, thereby enabling a cleaning member the clean the entire surface underlying a robotic surface cleaner.

When the suction member 110 is in the anchor condition, motion of the body 108 may be restricted or prevented due to the suction force securing the suction member 110 to the underlying surface. For instance, the body 108 may be limited to specific types of movement (e.g. rotational) and/or to defined ranges of motion (e.g. along a predefined length and/or path). Alternatively or in addition, certain portions of body 108 may have their movement prevented or restricted when the suction member 110 is in the anchor condition.

In the release condition, the suction force is released and suction member 110 is disengaged from the surface 105. The release condition allows the suction member 110 to move freely relative to the surface 105. When every suction member 110 is in the release condition the mobile body 108 of the surface cleaner 100 can be freely movable along the surface 105.

For example, the surface cleaner 100 may be operable in a robot translation mode while each and every suction member 110 is maintained in the release condition. In the robot translation mode, the base/body 108 can be translated freely relative to the underlying surface 105 to allow the robotic surface cleaner 100 to re-position itself.

In the robot translation mode, the floor engaging members 140 can provide a driving force to drive motion of the body 108 along the surface 105. Optionally, the floor engaging members 140 may be the sole driving members for the robotic surface cleaner 100.

Alternatively or in addition, motion of the vacuum cleaner body 108 can be driven by a cleaning member drive force provided by cleaning members, such as rotatable brush members 122. For example, rotatable brush members 122 can rotate and provide a drive force to propel the robotic surface cleaner 100 along an underlying surface 105 while concurrently performing a cleaning operation on the surface 105.

Each suction member 110 may be operable to provide a sufficient hold force to retain the suction member 110 fixed in position relative to surface 105. Various different types of suction devices may be used as suction members. In general, each suction member can be positioned to engage the underlying surface 105 and apply a pressure gradient that causes suction to retain the suction member 110 in its fixed anchor location relative to the surface 105.

Examples of suction members can include static suction members that can be placed onto the surface 105 in such a manner as to cause air to be expelled from a region underlying the suction member and enclosed between the suction member and the surface 105 to create a vacuum. A static suction member, such as an elastomeric suction cup, may be at least partially collapsible so as to expel air from the interior of the static suction member to thereby provide a sealed vacuum interior to the static suction member. The pressure differential between this vacuum and the air surrounding the exterior of the suction member can exert a static suction force that retains the suction member in position.

Optionally, a static suction member may be manufactured from a flexible material or include flexible portions or sections. The suction member can be positioned to establish a substantially sealed suction cavity 111 that is surrounded by the suction member 110 and that is closed by the surface 105. If the suction member is made from or comprises a flexible material (e.g., flexible regions thereof) the suction member or the flexible portion(s) thereof can then be flexed (e.g. depressed) to expel air from the suction cavity 111 thereby creating a vacuum.

Optionally, any suction member 110 may include a sticky material or coating or member around part or all of the contact perimeter between the suction member 110 and the underlying surface 105. This may help maintain the seal between the suction member 110 and the surface 105 and ensure that the suction cavity 111 remains sealed.

Alternatively or in addition, the surface cleaner 100 may include an active suction system coupled to an active suction member. For instance, a suction fan assembly may be coupled to a suction member to apply a suction force to the suction cavity 111 between the suction member and the surface 105 for part or all of the time that is required for the active suction member to be secured in position. The suction fan assembly may include a motor and fan assembly and an air flow pathway that extends between the motor and fan assembly and an upper portion of the suction member.

It will be appreciated that an active suction member may be rigid and the vacuum may be provided solely by the suction fan. Alternately, an active suction member may be the same as a static suction member, but with the use of a suction fan. In such a case, air may be actively extracted from the sealed suction cavity, for example, using a suction fan. The suction fan may enhance the vacuum provided by partially or fully collapsing a flexible (static) suction member to secure the cavity to surface 105. The suction fan may operate for part or all of the time (e.g., continuously) that the static suction member is positioned on surface 105.

Optionally, the vacuum cleaner may include a combined suction fan system operable to provide a suction force for one or more suction members 110 and to provide a cleaning suction force to draw dirty air into a dirty air inlet 130. This may help reduce the size of the robotic vacuum cleaner.

Alternatively, a suction member specific suction fan system may be included in the robotic surface cleaner 100. This may ensure that a sufficient suction force can be applied to secure the suction member 110 to an underlying surface regardless of the cleaning operations being performed by the robotic surface cleaner 100. Optionally, a separate suction fan system may be provided for each suction member or each set/pair of suction members.

Optionally, each suction member 110 can be individually controllable to adjust the condition of the suction member (e.g. between an anchoring condition and a release condition) such as by having its own suction motor or a suction motor connectable with two or more suction members and valves operable to adjust the flow to each of the suction members. This can allow the surface cleaner 100 to operate in a variety of different configurations while at least partially anchored to the underlying surface.

Each suction member 110 can be adjusted between an anchor condition and a release condition. Optionally, each of the suction members 110 can be adjusted individually and independently from the other suction members 110.

Alternatively, groups or sets of suction members 110 may be collectively adjusted (e.g. outer suction members 110b may be adjustable as a set while a central suction member 110a is separately adjustable). Optionally, the collectively adjustable set of suction members 100 can include all of the suction members 110 for a given surface cleaner 100 (i.e. all of the suction members 110 may be collectively adjusted between the anchor condition and the release condition).

Optionally, each suction member 110 can be individually controllable to adjust a suction force level of the suction force being applied for that suction member in the anchor condition. This may allow the surface cleaner 100 to operate with different levels of downforce being applied by the suction members 110 to facilitate different cleaning operations.

Alternatively, the suction force level for a group or set of suction members 110 may be collectively adjusted (e.g. outer suction members 110b may be adjustable as a set while a central suction member 110a is separately adjustable). Optionally, the suction force level for all suction members 110 can be adjusted collectively for a given surface cleaner 100.

Optionally, each suction member 110 can be adjusted between an extended position (see e.g. FIG. 1D) and a retracted position (see e.g. FIG. 1C). In the extended position, the suction member 110 can extend downwardly away from the bottom end 104 of surface cleaner 100 to a position that engages the surface 105. This enables the suction member 110 to be secured to the surface 105 by the suction force. This may also ensure that the suction member 110 can establish sufficient contact with the surface 105 to establish or maintain the required suction force, for instance where the surface 105 is graded or unlevel.

In the retracted position, the suction member 110 can be retracted relative to the surface 105 such that the suction member 110 does not contact, and is spaced apart from, the surface 105 (or at least retracted from the level of the bottom of the floor engaging members). The retracted position can prevent the suction member 110 from interfering with or inhibiting the motion of the vacuum cleaner body 108 (and suction member 110) relative to the surface 105 while the suction member 110 is in the release condition.

A suction member 110 may be adjusted between the extended position and the retracted position using a suction member elevation member or elevation system such as a vertical lift (e.g. a vertical actuator, piston etc.) to adjust the position of the suction member and/or by a user manually moving the suction member.

Optionally, the suction member 110 may be required to be in the extended position to transition into the anchor condition. That is, the suction member 110 may be prevented from transitioning into the anchor condition while in the retracted position.

Alternatively, the suction member 110 may be capable of operating in an anchoring condition without having to adjust its position. For instance, the suction member 110 may remain in a fixed position (e.g. a retracted position) while still applying a suction force (e.g. using an active suction system).

Alternatively or in addition, the suction member 110 may still contact an underlying surface (e.g. a carpet or flooring) without being moved to an extended position (e.g. maintained in a fixed position or in the retracted position) thereby ensuring that the suction force can still be applied to secure the suction member 110 to the underlying surface 105.

The robotic surface cleaner 100 can include suction members 110 in a variety of arrangements. For example, a central suction member 110a may be provided at a central location of the suction member body 108 (e.g. at a location equidistant from the opposing side walls 106 of the body) as shown in the examples of FIGS. 1A-1F, 1I, and 1J. A central suction member 110a can provide a substantially consistent downforce across the underside 104 of the body 108. The central suction member 110a may also provide a central axis about which the body 108 can be rotated (e.g. where the central suction member 110a is rotatably mounted to body 108).

Optionally, the central suction member 110a may be the sole suction member for the robotic surface cleaner 100 (e.g. as shown in FIGS. 1A-1D).

Alternatively, the robotic vacuum cleaner can include a plurality of suction members 110 as shown in the examples of FIGS. 1E-1H. In some examples, the plurality of suction members may include at least three suction members (see e.g. FIGS. 1E, 1F, 1H, 2A-2F, 3A-3F, 4A-4B, and 5A-5F).

Including a plurality of suction members 110 can provide the robotic surface cleaner 100 with greater flexibility to operate with one or more suction members 110 in an anchor condition. This may allow the robotic surface cleaner 100 to operate in a variety of different cleaning modes and/or motion modes. A plurality of suction members 110 may also allow the robotic surface cleaner 100 to increase the downforce applied when cleaning operations are performed, for instance to facilitate spot cleaning or stain removal.

The plurality of suction members 110 can include one or more outward suction members 110b. The outward suction members 110b can be positioned at an outward portion of the base 104 of body 108, proximate to the sides 106. The plurality of outward suction members 110b can be provided by one or more periphery suction members. Each periphery suction member can be positioned at the periphery of the base 104, e.g. adjacent to the sides 106.

Optionally, the plurality of suction members 110 can include a plurality of periphery suction members. The plurality of periphery suction members can be spaced apart along the periphery of the base 104 (e.g. circumferentially spaced as shown in the examples of FIGS. 1E-1H). The plurality of periphery suction members can include three (3) or more periphery suction members (e.g. four suction members as shown in the examples of FIGS. 1F and 1H).

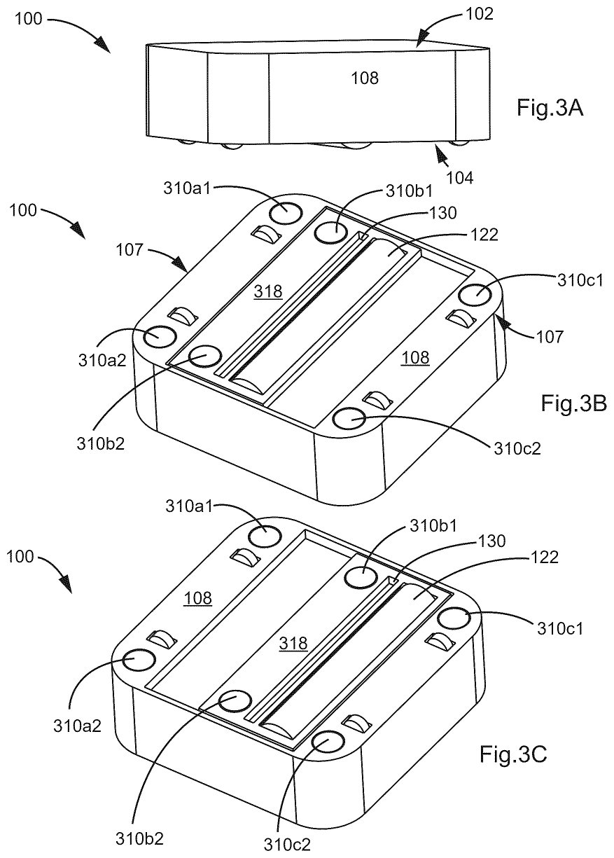

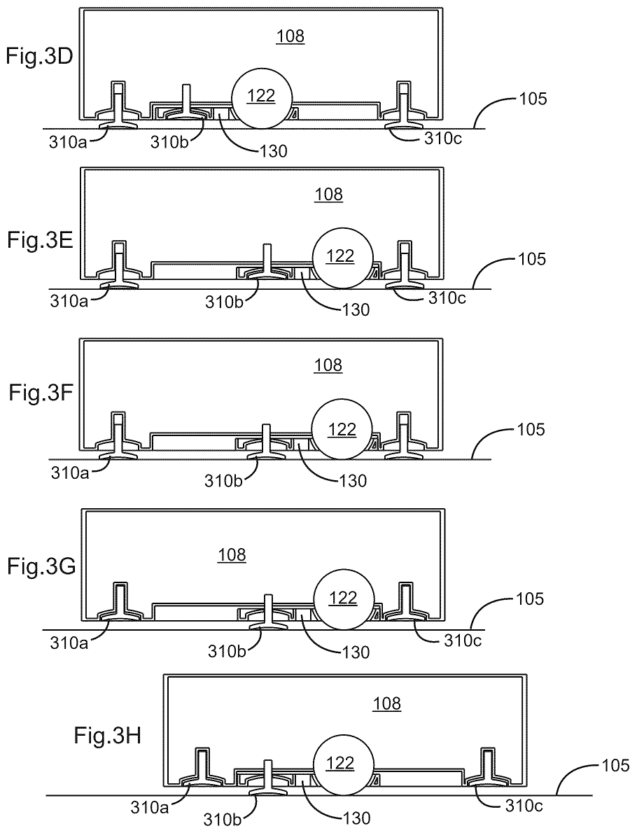

The outward suction members 110b may be positioned radially outward relative to the cleaning members 122, as shown for example in FIGS. 3E and 3F. That is, the outward suction members 110b can be positioned radially outward from the cleaning members 122 along the base 104 of body 108 (i.e. closer to the sides 106 as compared to cleaning members 122). Positioning a plurality of outward suction members 110b radially outward from the cleaning members 122 may ensure that a consistent downforce is applied across the extent of the cleaning members 122 thereby ensuring a more consistent cleaning operation throughout the entirety of the cleaning member 122.

Alternatively or in addition, the plurality of suction members 110 can include one or more inward suction members 110. The inward suction members can be positioned at an inward portion of the base 104 of body 108 relative to the at least one cleaning member 122. Central suction member 110a is an example of an inward suction member 110. Optionally, the plurality of suction members 110 can include both an inward suction member and at least one outward suction member positioned at an outward portion of the base relative to the at least one cleaning member (e.g. as shown in the examples of FIGS. 1E and 1F).

Optionally, the plurality of suction members 110 can include a central suction member 110a (e.g. as shown in FIGS. 1E and 1F). Alternatively, the plurality of suction members 110 may omit a central suction member (e.g. as shown in FIGS. 1G and 1H).

Optionally, the suction members 110 may be offset from (e.g., spaced from in the plane of the lower surface of body 108) one or more cleaning members 122 on the base 104 of the body 108 to facilitate cleaning operations. For example, the suction members 110 can be radially spaced from one or more cleaning members 122 on the base 104 of the body 108. This may allow the cleaning members 122 to perform cleaning operations while the suction members 110 are in the anchor condition without the suction members 110 interfering with the operations of the cleaning members 122. For example, the cleaning members 122 (and optionally a portion of body 108 to which they are mounted) may be rotatable while the suction members are in the anchor condition to thereby clean an angular surface region while the surface cleaner remains in a fixed location above the surface.

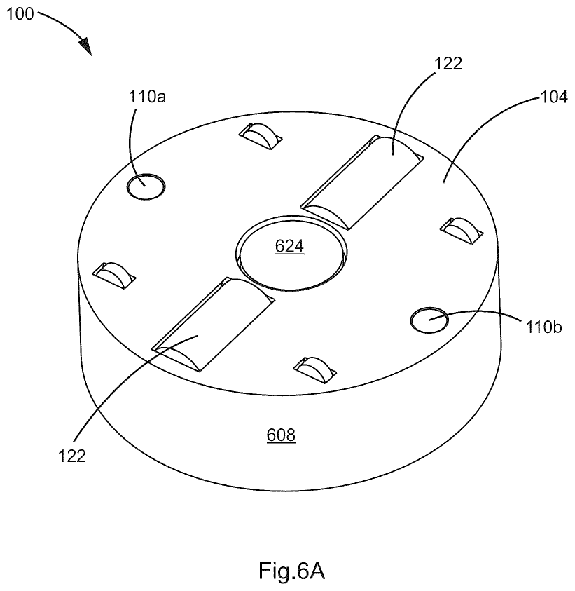

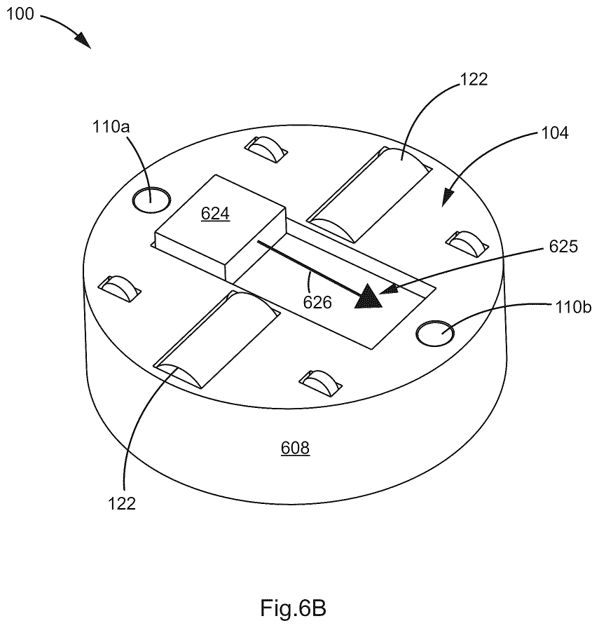

Alternatively or in addition, one or more suction members 110 may be aligned with one or more cleaning members 122 on the base 104 of the body 108. For example, one or more cleaning members 122 may be radially aligned with one or more suction members 110 (e.g. circumferentially spaced around the base 104 as shown in the examples of FIGS. 6A and 6B). This may allow the cleaning members to perform an initial cleaning operation on the underlying surface 105 prior to securing the suction members 110 to the surface 105. This may provide an at least partially cleaned surface region to facilitate establishing a seal between the suction member 110 and the surface 105.

One or more cleaning members 122 may be movable while one or more suction members 110 are in the anchored condition. This can enable the cleaning members 122 to clean a surface region while an added downforce is provided by the suction members 110 in the anchored condition.

For example, a suction member 110 may be movably mounted to the body 108 of the robotic vacuum cleaner. With a suction member 110 movably mounted to the body 108, at least a portion of the body 108 may be movable relative to the suction member 110 while the suction member 110 remains in a fixed position in the anchoring condition. Thus, the body 108 (or a portion thereof) containing a cleaning member 120 can be moved even when one or more suction members 110 are provided in an anchor condition. The surface cleaner 100 can thus perform cleaning operations while the suction force securing the suction member 110 in the anchoring condition provides an added downforce to assist in the cleaning operations.

Optionally, a suction member 110 may be rotatably mounted with respect to the body 108 of the robotic vacuum cleaner. In the example shown in FIGS. 1A-1D, the body 108 may be capable of rotating relative to the suction member 110 while the central suction member 110a is in the anchoring condition. The suction member 110 can define a central rotation axis 113 about which the body 108 can rotate while the central suction member 110 is in the anchoring condition. The body 108 of the robotic surface cleaner 100 can then rotate about the central rotation axis 113 to perform a cleaning operation while the suction member 110 is secured to the underlying surface 105 in the anchoring condition. Accordingly, the cleaning members 120, 122 may clean an annular region having a radial width equal to the axial relational length of the cleaning members 120, 122.

Alternatively or in addition, a cleaning member 120 may be movably mounted to the body 108 or a portion thereof. The cleaning member 120 may thus move relative to body 108 while the suction member 110 is in an anchor condition. For example, one or more cleaning members may be provided on a rotatable portion of the body 108 such as a rotating ring section. This may allow the cleaning members 120 to clean an annular floor region while the surface cleaner 100 remains in place with the suction members 110 secured to the underlying surface 105.

In the examples shown in FIGS. 1E-1G, a pair of rotatable brush members 122 are provided as the cleaning members. The pair of rotatable brush members 122 may be mounted to the body 108 in such a manner as to allow the brush members 122 to travel along a circular path while the body 108 remains fixed at a location with one or more of the suction members 110 in the anchor condition. For example, the central suction member 110a may be rotatably mounted with respect to the body 108 such that the body 108 is rotatable while the central suction member 110a is in the anchor condition thereby allowing the brush members 122 to travel in a circle. Alternatively, the rotatable brush members 122 may be mounted to a rotatable portion of the body 108 (e.g. a rotatable annular portion in the example of FIGS. 1E-1F or a circular rotatable portion in the example of FIG. 1G).

Optionally, the rotation of the brush members 122 while performing cleaning operations can drive motion of the body 108 relative to the underlying surface. For example, the rotation of the brush members 122 can drive rotation of the body 108 (or rotatable portion thereof) to which the brush members 122 are mounted. Further optionally, rotation of the brush members 122 may be used to drive motion of the body 108 when the suction members 110 are in the release condition thereby allowing the body 108 to move freely relative to the surface 105.

Alternatively or in addition, the cleaning member(s) may be linearly movable relative to the suction member(s) 110. For example, a linearly movable cleaning member may be provided as shown in the examples of FIGS. 2A-2H, 3A-3H and 6B. Optionally, the linearly movable cleaning member may be mounted to a portion of body 108 that is linearly movable while one or more suction member(s) 110 are in an anchor condition.

As shown in the examples of FIGS. 2A-2H, 3A-3H and 6B, a linearly movable cleaning member may be provided as a single abrasive cleaning member. Alternatively, a plurality of cleaning members may be provided that are movable relative to the suction members 110.

In the examples shown in FIGS. 1A-1H, the cleaning member(s) 120 are provided in the form of cleaning brushes 122. Alternatively or in addition, a cleaning member 120 may be provided as a cleaning pad 124 as shown in the example of FIG. 1I. The cleaning pad 124 can be mounted to the base 104 of body 108 and can clean an underlying surface region 105 when the surface cleaner passes along the surface 105. This may provide an abrasive cleaning member 120 that does not require a motor to drive operation of the cleaning member.

Optionally, as shown in the example of FIG. 1J, surface cleaner 100 can include a dirt inlet 130 for receiving dirt from a surface. In the illustrated example, the dirt inlet 130 is a dirty air inlet through which dirty air can be suctioned. The surface cleaner 100 can also include a clean air outlet (not shown) and an air flow path extending between the clean air outlet and the dirty air inlet 130.

At least one suction motor and at least one air treatment member can optionally be provided in the air flow path. The suction motor can be drivingly connected to a first fan provided in the airflow pathway. The air treatment member may be any suitable air treatment member, including, for example, one or more air treatment chambers such as non-cyclonic air momentum separators or cyclones, filters, bags and other dirt separation devices. In addition to the at least one air treatment member, one or more pre-motor filters (positioned in the air flow path between the air treatment member and the suction motor) and/or one or more post-motor filters (positioned in the air flow path between the suction motor and the clean air outlet) may be provided.

Optionally, the surface cleaner can use the same suction motor to draw air in through the dirt inlet 130 and to establish the suction force between at least one of the suction members and the surface. Alternatively, a separate suction motor and fan assembly can be used to establish the suction force for the at least one suction member. Further optionally, a plurality of suction motor and fan assemblies may be provided for different suction members.

Although the brushing member 122 is shown located at the dirt inlet 102 in surface cleaner 100, it should be understood that in alternative embodiments the dirt inlet 102 may be spaced apart or otherwise located apart from the brushing member 120.

### Surface Cleaner Operational Modes

The following is a description of a robotic surface cleaner operable in one or more operational modes. It will be appreciated that the features of the robotic surface cleaner operable in one or more operational modes may be used alone or in combination with various other features of an autonomous surface cleaner described herein, such as a robotic surface cleaner having one or more suction members, a robotic surface cleaner with a mobile cleaning section, a robotic surface cleaner operable with one or more stain detection sensors, a robotic surface cleaner operable with one or more fluid dispensers, a robotic surface cleaner operable with one or more disinfectant members, a robotic surface cleaner having a carpet cleaning suction member, a robotic surface cleaner having a suction member cleaning unit, and a surface cleaning method.

The operational modes can include cleaning modes that define the manner of cleaning operations performed by the robotic surface cleaner on an underlying surface being cleaned. The following description contains various features which may be used individually or in any combination or sub-combination.

A robotic surface cleaner 100 having one or more suction members 110 can be configured to operate in a plurality of operational modes. The operational modes can include cleaning modes as well as non-cleaning modes, such as navigational modes in which the surface cleaner 100 is moved to a region to be cleaned.

The cleaning operational modes can include an anchored cleaning mode. In the anchored cleaning mode, at least one cleaning member 120 can operate to clean the surface 105 below the surface cleaner 100 while at least one of the suction members 110 is secured to the surface 100 in the anchor condition. This can provide an added downforce for the cleaning member 120 performing the cleaning operation.

The cleaning member 120 may be movable while the surface cleaner 100 is in the anchored cleaning mode. Optionally, the cleaning member 120 may be movable while the body 108 of the surface cleaner 100 remains in a fixed position. For example, a rotatable cleaning brush 122 can be rotated while the body 108 is maintained in a fixed position by the at least one suction member 110.

Alternatively or in addition, a cleaning member 120 may be provided by, or mounted to, a movable portion of body 108 that is movable while the surface cleaner 100 is in the anchored cleaning mode (i.e. while at least one suction member 110 is secured to surface 105). The movable body portion can move relative to a second body portion (e.g. a static or fixed body portion) while the surface cleaner 100 is in the anchored cleaning mode.

Alternatively or in addition, the body 108 may be movable relative to the at least one suction member 110 that is fixed in the anchor condition. That is, the suction member 110 may be movably mounted to the body 108 such that body 108 can move relative to the suction member 110 while the suction member 110 is in an anchor condition. The cleaning member 120 may then perform cleaning operations over a region of the underlying surface 105 as the body 108 moves along the surface 105.

In these alternately embodiments, the cleaning member 120 may therefore be movable with respect to the surface being cleaned while the body 108 of the surface cleaner 100 remains in a fixed position so that a portion of the floor, that is greater than the footprint of the cleaning member 120 may be cleaned.

The cleaning operational modes can include a mobile cleaning mode. In the mobile cleaning mode, at least one cleaning member can be operable to clean the surface 105 while the base 108 moves along the surface 105.

In the mobile cleaning mode, the suction force applied by the suction member(s) 110 may be reduced or completely removed to allow the base 108 to move along surface 105. For example, at least one suction member 110 may be maintained in a release condition to enable the base 108 to move freely along the surface 105. Optionally, every suction member 110 can be maintained in the release condition while operating in the mobile cleaning mode.

The surface cleaner 100 can be configured to move in various manners in a mobile cleaning mode. For example, the surface cleaner 100 may be operable to rotate or pivot about a rotational axis defined by a suction member that is maintained in the anchor condition. The suction member can be rotatably mounted to the base to enable the base 108 to pivot or rotate relative to the surface 105 while the suction member is maintained in the anchor condition.

The motion of the base 108 in the mobile cleaning mode can vary depending on the number and location of the suction member(s) 110 that are in the anchor condition. For example, if a central suction member 110a is maintained in the anchor condition, then the base 108 may rotate about a central rotational axis defined by the central suction member 110a while in the mobile cleaning mode. In this configuration, the cleaning member(s) 122 can be used to clean an annular region on the surface 105.

Alternatively, a different suction member, such as an outer suction member 110b may be maintained in the anchor condition while the base 108 is rotatable about a pivot axis defined by the suction member 110b. The base 108 may then pivot about the pivot axis associated with suction member 110b to clean the surface 105. Accordingly, the base 108 may travel along the surface 105 in a curved or snake-like path by iteratively engaging an outer suction member 110b in the anchor condition, pivoting about the pivot axis defined by the outer suction 110b, releasing the outer suction member 110b and adjusting another suction member 110 to the anchor condition.

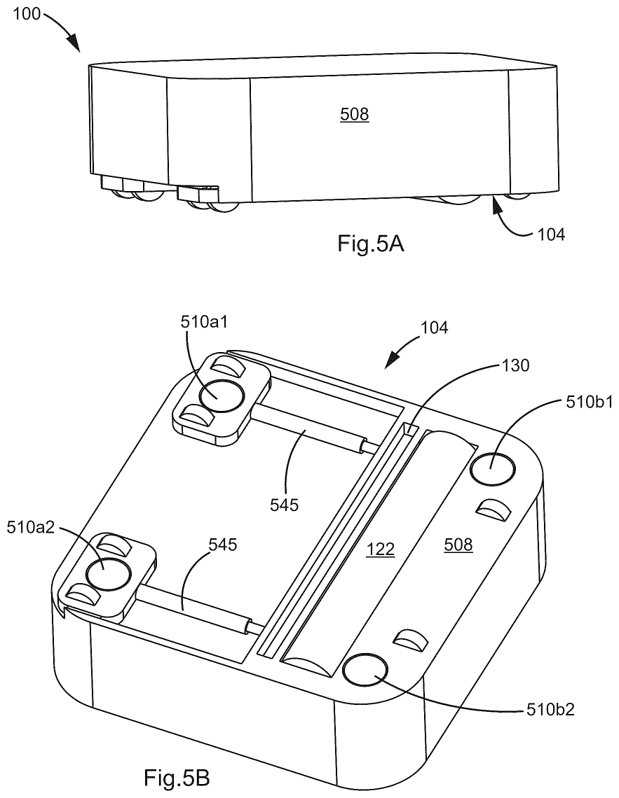

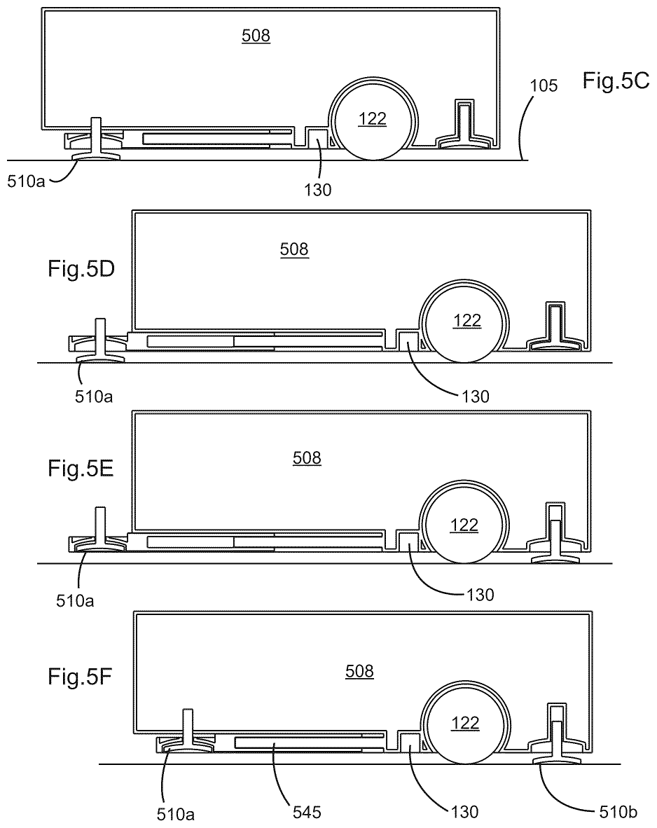

More generally, however, a suction member 110 can define an anchor point or anchor location while in the anchor condition. Referring to the example shown in FIG. 5A-5F, base 508 can be movable along an incremental travel distance relative to the anchor location while the suction member 510a is in the anchor condition (see e.g. FIGS. 5C and 5D). As exemplified in FIG. 5C, the primary suction member 510a is in an anchor condition. In the embodiment of FIGS. 5C-5F, the base moves to the right, which will be referred t as the forward direction. Accordingly, primary suction member 510a is at the rear end and suction member(s) 510b are at the front end. Base 108 may then be pushed forwardly relative to primary suction member 510a. When the base 108 is moving, suction members 510b are in the release condition. Once the base 508 has travelled the length of the incremental travel distance (See FIG. 5D), the anchor location can be adjusted to allow the base 108 to travel further in, e.g., the same direction.

The anchor location of the primary suction member 510a can be adjusted by releasing the primary suction member 510a from the anchor condition, optionally moving suction members 510b to the anchor position (FIG. 5E), and repositioning the primary suction member 510a in a new forward position (FIG. 5F) prior to re-adjusting the suction member 510a to the anchor condition. For example, the suction member 510 may be provided on an arm 545 that is moveable in the desired direction relative to the base 508, such as by a linear actuator, worm gear drive or the like and/or by a user manually moving the suction member (see e.g. FIGS. 5A-5F).

Once the base 508 has reached a particular position, such as the end of its motion pathway (relative to the suction member 510a in the anchor condition, see FIG. 5D), the suction member 510a can be adjusted from the anchor condition to the release condition as shown in FIG. 5E. The primary suction member 510a can then remain in the release condition and move relative to the base 508 to return to its initial position as shown in FIG. 5F, e.g., retracted under the base 108.

The base 508 can remain in place (relative to the underlying surface 105) while the suction member 510a returns to a particular position, such as its initial position. With the suction member 510a returned to the initial position, the suction member 510a can then be adjusted to the anchor condition to define a new anchor location and enable the base 508 to travel along its motion pathway once again relative to the new anchor location. The process shown in FIGS. 5C-5F can then be repeated to move the base 508 further along the surface 105. This can provide an incremental method of moving the surface cleaner along the underlying surface 105 while performing cleaning operations with added downforce provided by the suction member 510a in the anchor condition.

It will be appreciated that in an alternate embodiment, the left side of the base 108 in FIGS. 5C-5F may be the forward side and the arm 545 extended to position the primary suction member 510a in a forward anchor position (i.e. left of base 108) and the base may be pulled forwardly along arm 545 towards primary suction member 510a.

The example shown in FIGS. 5A-5F illustrate a surface cleaner 100 configured to travel incrementally along a linear path while performing cleaning operations. However, the surface cleaner 100 can be configured to travel along pathways of various configurations depending on the arrangement and operation of the suction members 110. For instance, the surface cleaner 100 may be operable to travel along a snake-like path by pivoting around a sequence of suction members, such as the suction members 110b1-110b4 shown in FIG. 1F. Alternatively or in addition, the surface cleaner 100 may be operable to travel along an irregular pathway by selectively adjusting particular suction members 110 between the anchor condition and release condition.

In the mobile cleaning mode, motion of the base 108 may be driven by a drive member such as a wheel 140. Optionally, the floor engaging members (e.g. wheels 140) may be the sole driving force in the mobile cleaning mode.

Alternatively, motion of the base 108 may be driven (wholly or in part) by a drive force provided by a cleaning member, such as a drive force provided by the rotation of a rotatable brush cleaning member. The rotating brush member can provide the sole driving force or a supplemental driving force for the base 108 while operating in the mobile cleaning mode.

In the mobile cleaning mode, rotation of the brush member(s) 122 can be selectively controlled to move the surface cleaner in a desired direction. For example, the surface cleaner may be operable in a forward motion mode and a reverse motion mode while in the mobile cleaning mode (or any other mobile mode). The at least one cleaning member can be controlled to rotate in opposite directions in the forward motion mode and the reverse motion mode.

The surface cleaner may also be operable in a turning mode to change the direction of travel for the surface cleaner 100. Rotation of the brush member(s) 122 can also be controlled to turn or rotate the surface cleaner 100. For example, in the turning mode, a first cleaning member and second cleaning member can be rotated in opposite directions to provide a turning force that adjusts a direction of motion of the base 108. Alternatively, a single cleaning member may be activated to provide the turning force to adjust the direction of motion of base 108.

Optionally, the surface cleaner 100 may be operable in a spot cleaning mode. The surface cleaner 100 can be configured to perform a spot cleaning operation to clean specified surface regions and/or surface regions that have been identified as being stained or particularly unclean. The surface cleaner 100 can perform spot cleaning in response to receiving a spot cleaning signal or stain detection signal indicating a particular surface region requiring cleaning. The surface cleaner 110 can then navigate to the identified surface region and perform cleaning operations (e.g. in an anchored cleaning mode).

Optionally, the surface cleaner 100 may be operable in a multi-stage anchored cleaning mode. The multi-stage anchored cleaning mode can include a preliminary cleaning stage prior to securing the at least one suction members 110 to the surface 100 in the anchor condition to operate in the anchored cleaning mode.

In the preliminary cleaning stage, the surface cleaner 100 can be operated to initially clean a first region of a surface underlying the surface cleaner while the surface cleaner is at a first position overlying the first region. Following the initial cleaning of the first region, the surface cleaner can be secured in the first position by applying at least one suction member to the surface within the first region and placing it in an anchor condition (i.e. by adjusting the at least one suction member to the surface within the first region). This may ensure that the underlying surface region is sufficiently clean to establish a secure seal between the at least one suction member and the underlying surface region.

The surface cleaner can then be operated to clean the first region while the surface cleaner is maintained in the first position by the at least one suction member (e.g. in an anchored cleaning stage). This can allow the surface cleaner to perform a more thorough cleaning operation on the underlying surface region.

Optionally, the surface cleaner 100 may have different cleaning members that are operable in the preliminary cleaning stage and the anchored cleaning stage. For example, the surface cleaner 100 may include a first set of cleaning members used to perform the preliminary cleaning operation and a second set of deep cleaning members used to perform the anchored cleaning operation. Alternatively, the same cleaning members may be used to perform the preliminary cleaning stage and the anchored cleaning stage.

In the example illustrated in FIG. 6A, the first set of cleaning members can include one or more cleaning brushes 122 and the second set of cleaning members can include a rotatable scrubbing member 624. In the example of FIG. 6A, the one or more cleaning brushes 122 are aligned with the suction members 110a and 110b while the scrubbing member 624 is offset from the suction members 110a and 110b.

The cleaning brushes 122 can be used in the preliminary cleaning stage to initially clean the surface region below the surface cleaner 100, for example to clean the surface region underlying the suction members 110a and 110b. The rotatable scrubbing member 624 can be used in the anchored cleaning stage to perform a more thorough cleaning operation on the underlying surface region, once the suction members 110a and 110b have been adjusted to the anchor condition on the partially cleaned surface.

The surface cleaner 100 can include various other types of cleaning members. For instance, in the example illustrated in FIG. 6B, the second set of cleaning members can include a translatable central scrubbing member 624. The cleaning member 624 can translate relative to the surface 105 to thereby clean the surface while at least one of the suction members 110b is secured to the surface in the anchor condition.

The translatable central scrubbing member 624 can be movable along a linear path 626 within a scrubbing region 625 of the base 108. The translatable scrubbing member 624 may be used to perform a more thorough cleaning operation on the underlying surface region when in an anchored cleaning mode.

Surface Cleaner with Mobile Cleaning Section

The following is a description of a robotic surface cleaner with a mobile cleaning section. It will be appreciated that the features of the robotic surface cleaner with a mobile cleaning section may be used alone or in combination with various other features of an autonomous surface cleaner described herein, such as a robotic surface cleaner having one or more suction members, a robotic surface cleaner operable in one or more operational modes, a robotic surface cleaner operable with one or more stain detection sensors, a robotic surface cleaner operable with one or more fluid dispensers, a robotic surface cleaner operable with one or more disinfectant members, a robotic surface cleaner having a carpet cleaning suction member, a robotic surface cleaner having a suction member cleaning unit, and a surface cleaning method.

The mobile cleaning section can perform cleaning operations while moving relative to one or more suction members that are fixed in place on the underlying surface being cleaned. The following description contains various features which may be used individually or in any combination or sub-combination.

A mobile cleaning section generally refers to a portion of the surface cleaner that includes at least one cleaning member 122 and is movable when performing cleaning operations. The mobile cleaning section can be movable relative to the main body 108 while the main body portion 108 remains in a fixed position, for instance maintained in place by a suction member 110 and/or while the base 108 is moving.

Referring to FIGS. 2A-2H, shown therein is an example of a surface cleaner 100 that includes a mobile cleaning section 218. The mobile cleaning section 218 is mounted to a main body 108. In the example illustrated, the mobile cleaning section 218 can move along a portion of an underlying surface region 105 while the main body 108 remains fixed in place relative to the surface 105.

The main body 108 includes a plurality of suction members 210a. The suction members 210a1 and 210a2 can be adjusted to the anchor condition when the surface cleaner 100 is positioned at a desired cleaning location (e.g. as shown in FIG. 2D).

The mobile cleaning section 218 includes at least one cleaning member 120. In the example illustrated, a rotatable brushing member 122 is provided on the mobile cleaning section 218. Optionally, a dirt inlet 130 is also provided on the mobile cleaning section 218 in a fixed relationship to the cleaning member 120. This can ensure that dirt and debris that is dislodged by the cleaning member 120 can enter the dirt inlet 130.

The surface cleaner 100 can operate in an anchored cleaning mode with the main body 108 maintained in a fixed position by at least one of the suction members 210a1 and 210a2 being secured to the surface 105 in the anchor condition. In the anchored cleaning mode, the cleaning member 122 and dirt inlet 130 (along with the whole of the mobile cleaning section 218) can move relative to the main body 108 while main body 108 remains in a fixed position.

In the anchored cleaning mode, the mobile cleaning section 218 can perform a cleaning operation over a section of the underlying surface 105. Once the mobile cleaning section 218 completes the cleaning operation, the suction members 210a1 and 210a2 secured to the surface 105 can be adjusted to the release position and the main body 108 can be repositioned, e.g., using any drive means disclosed herein. The surface cleaner may then revert to the anchor cleaning mode to perform further cleaning operations as desired using the mobile cleaning section.

Optionally, the surface cleaner can include a first set of suction members 210a and a second set of suction members 210b. In the example shown in FIGS. 2A-2H, the first set of suction members 210a are mounted to the main body 108 and the second set of suction members 210b are mounted to the mobile cleaning section.

When the surface cleaner is in the anchored cleaning mode, the second set of suction members 210b can be maintained in the release condition. This can allow the second set of suction members 210b to be movable relative to the surface 105 thereby facilitating movement of the mobile cleaning section. At the same time, the first set of suction members 210a can be secured to the surface in the anchor condition. This can ensure that the main body 108 remains in a fixed position and may also provide additional downforce to assist in the cleaning operations.

Each set of suction members can include at least one suction member. Optionally, each set of suction members may include at least two suction members. In the example shown in FIGS. 2A-2H, the first set of suction members 210a includes a pair of suction members 210a1 and 210b1 while the second set of suction members 210b also includes a pair of suction members 210b1 and 210b2.

FIG. 2D-2H illustrate an example cleaning process that may be performed by a surface cleaner with a mobile cleaning section. In FIG. 2D, the surface cleaner 100 can be secured in an initial fixed position with the first set of suction members 210a secured to the surface 105 while the second set of suction members 210b are in the release condition (and also in a retracted position in the example illustrated).

The surface cleaner 100 can then operate in an anchored cleaning mode. In the anchored cleaning mode, the mobile cleaning section (including cleaning member 122 and dirt inlet 130) can perform cleaning operations as it moves relative to the main body 108 with the first set of suction members 210a and the main body 108 maintained in a fixed position. The mobile cleaning section can complete its cleaning operations as it moves to its end position as shown in FIG. 2E, which could be considered movement in a forward direction.

The mobile cleaning section may then return to its original position (shown in FIG. 2D). Optionally, the mobile cleaning section may simply traverse the reverse path to return to its original position.

Alternatively, the mobile cleaning section may be secured in a fixed position while the surface cleaner adjusts to a repositioning mode. In the repositioning mode, the second set of suction members 210b can be secured to the surface 105 in the anchor condition and the first set of suction members 210a can be in the release condition and movable relative to the surface 105 to reposition the first set of suction members 210a.

As shown in FIG. 2F, after moving to the cleaning end position the second set of suction members 210b can be adjusted to the anchor condition to maintain the mobile cleaning section in a fixed position at the end of the previous cleaning operation. With the second set of suction members 210b in the anchor condition, the first set of suction members 210a can be disengaged and adjusted to the release condition as shown in FIG. 2G. This can then allow the first set of suction members 210a and main body 108 to move, e.g., forwardly, relative to the surface 105 (and relative to the mobile cleaning section 218) in the repositioning mode.

The main body 108 can then travel, e.g., forwardly, relative to the mobile cleaning section 218 to return the mobile cleaning section to its start position relative to the main body 108 as shown in FIG. 2H. The surface cleaner 100 may then adjust to a subsequent anchored cleaning mode by adjusting the first set of suction members 210a to the anchor condition and adjusting the second set of suction members 210b to the release condition. The surface cleaner 100 can thus return to the condition shown in FIG. 2D, albeit with the main body 108 moved to a new fixed position.

The surface cleaner can be configured to operate sequentially in the anchored cleaning mode and the repositioning mode. For example, the surface cleaner can be configured to iteratively repeat the anchor cleaning mode and the repositioning mode while cleaning a surface region. This can help ensure that the surface cleaner performs cleaning operations over an extended surface area with added downforce provided by the first set of suction members 210a.

Optionally, the mobile cleaning section 218 may be movable relative to the main body 108 along a predefined path. For instance, in the example shown in FIGS. 2A-2H, the mobile cleaning section 218 is movable relative to main body 108 along a linear path in the lateral direction 217.

It will be appreciated that the mobile cleaning section 218 may move forwardly and rearwardly repeatedly to scrub a surface before the base 108 is repositioned.

Alternatively, the mobile cleaning section 218 may be movable relative to an anchored suction member 110 in various directions or paths. For instance, the mobile cleaning section may be a circular or annular cleaning section that can rotate relative to the main body 108. For example, the cleaning members 122 shown in FIGS. 1E and 1F may be provided as part of an annular cleaning section (not shown) that is rotatable relative to the suction members 110a and 110b. As another example, the cleaning members 124 shown in FIG. 1I and cleaning members 122 and dirt inlet 130 shown in FIG. 1J may be provided as part of an annular cleaning section (not shown) that is rotatable relative to a central suction member 110a. As a further example, the cleaning members 122 shown in FIGS. 1G and 1H may be provided as part of a circular cleaning section (not shown) that is rotatable relative to the suction members 110b.

FIGS. 3A-3H show another example of a surface cleaner 100 that includes a mobile cleaning section 318. The surface cleaner shown in FIGS. 3A-3H is generally similar to the surface cleaner shown in FIGS. 2A-2H except that multiple sets of suction members 310 are coupled to the main body 108. As illustrated, the suction members can include a first set of suction members 310a1 and 310a2 and a second set of suction members 310c1 and 310c2 coupled to different portions of the main body 108.

Both the second set of suction members 310c and the first set of suction members 310a can be secured to the surface 105 in the anchor condition (FIG. 3D) while the surface cleaner 100 operates in the anchored cleaning mode (the mobile cleaning section 318 moves to the position shown in FIG. 3D). That is, sets of suction members at opposing ends 107 of the main body 108 can operate in the anchored condition while the mobile cleaning section 318 performs a cleaning operation (e.g., moves linearly to clean the surface 105 one or more times). This can provide a more consistent downforce to enhance the cleaning operations of the mobile cleaning section 318.

In the example illustrated, the mobile cleaning section 318 includes a third set of suction members 310b. The third set of suction members 310b can be maintained in the release condition while operating in the anchored cleaning mode (FIGS. 3D-3E). The third set of suction members 310b can also be maintained in an anchor condition while operating in a repositioning mode. Accordingly, the second set of suction members 310c and the first set of suction members 310a may be moved to the release condition with the third set of suction members 310b in the anchor condition (FIG. 3F) and the base 108 moved forwardly (FIGS. 3G-3H).

Optionally, the mobile cleaning section can be provided as a body portion of the surface cleaner 100. For example, the surface cleaner 100 can include a first body portion 408a and a second body portion 408b as shown in the example of FIGS. 4A-4B. The first body portion 408a and second body portion 408b may be movable relative to one another between a first position (e.g. as shown in FIG. 4A) and a second position (e.g. as shown in FIG. 4B). This can enable the surface cleaner to operate in an anchored cleaning mode in which one of the first body portion 408a and second body portion 408b is maintained in a fixed position by a suction member 410 in the anchor condition while the other of the first body portion 408a and second body portion 408b is movable to perform a cleaning operation.

In the first position, the first body portion 408a and second body portion 408b can be positioned immediately adjacent to (and optionally contacting) one another. The first position may be referred to as a compact body position or retracted body position.

In the second position, the first body portion 408a and second body portion 408b can be positioned spaced apart from one another. The second position may be referred to as a separated body position or extended body position.

At least one of the first body portion 408a and second body portion 408b can include a cleaning section. In the example illustrated, the second body portion 408b includes a cleaning section in the form of a rotatable cleaning member 122 and dirt inlet 130. Alternatively or in addition, the first body portion 408a may include a cleaning section.

The cleaning section can be provided in a fixed position on the underside 104 of the surface cleaner 100 (e.g. on the underside of second body portion 408b as shown in FIGS. 4A and 4B). When the surface cleaner 100 operates in an anchored cleaning mode, the cleaning section (and thus cleaning member 122 and dirt inlet 130) can be translated by the motion of the second body portion 408b.

The example surface cleaner 100 shown in FIGS. 4A and 4B can be configured to operate in an anchored cleaning mode and repositioning mode as described herein above. For example, in the anchored cleaning mode the first body portion 408a can be maintained in a fixed position by the suction members 410a1 and 410a2 being secured to the surface 105 in an anchor condition. The suction members 410b1 and 410b2 on the second body portion 408b can be maintained in the release condition while operating in the anchored cleaning mode to allow the second body portion 408b to move freely and perform a cleaning operation, which may be one or more linear movements with respect to the first body portion 408a.

Once the cleaning operation is complete, the surface cleaner 100 can adjust to a repositioning mode in which the suction members 410b1 and 410b2 are adjusted to the anchor condition while suction members 410a are adjusted to the release condition to allow the first body portion 408a to be repositioned. The surface cleaner 100 shown in FIGS. 4A and 4B can be configured to operate sequentially in the anchored cleaning mode and repositioning mode, for example to perform an iterative cleaning process.

FIGS. 5A-5E show another example of a surface cleaner 100 that includes a mobile cleaning section. In the example shown in FIGS. 5A-5E, however, the mobile cleaning section is provided by the main body 508 of the surface cleaner 100. As illustrated in the example of FIG. 5B, a cleaning member 122 and dirt inlet 130 are provided on the underside 104 of the main body 508.

A set of arms 545 is attached to the main body 508. In the example illustrated in FIGS. 5A-5E, the set of arms includes a pair of arms, however it should be appreciated that a greater or fewer number of arms may be used.

Each arm 545 can be extendible relative to the main body portion 508. The arm 545 can extend between a first position (e.g. as shown in FIGS. 5B, 5C and 5F) and a second position (e.g. as shown in FIGS. 5D and 5E). In the first position, the arm 545 can be retracted to a position proximate to the main body 508. Optionally, the arm 545 can be nested below a portion of the main body 508 as shown in the example of FIGS. 5B, 5C and 5F. In the second position, the arm 545 can extend away from the main body portion 508 with a distal end of the arm 545 spaced apart from the main body 508.

Each arm 545 can be extendible and retractable relative to the main body portion 508. For example, the arm(s) 545 can extend and retract relative to the main body 508 in response to motion of the base 508 and/or a drive member drivingly connected to the arms 545.

Each arm 545 can have a corresponding suction member 510a attached thereto. The arm 545 can connect the corresponding suction member 510a to the main body 508. The suction member 510a can be provided at the distal end of each arm 545. Accordingly, when the arm 545 is in the second position the corresponding suction member 510a can be positioned away and spaced apart from the main body 508.

The suction members 510a can be used to provide an anchored cleaning mode of the surface cleaner 100. For example, the suction members 510a can be adjusted to an anchor condition to secure the arms 545 to a surface 105 underlying the surface cleaner 100. The main body 508 may then move relative to the arms 545 to perform a cleaning operation while the suction member(s) 510a remain in the anchor condition and maintain the distal end of the arms 545 in a fixed position. Once the cleaning operation is complete, the suction member(s) 510a can be adjusted to the release condition to allow the arms 545 to move relative to the surface 105. This can enable the surface cleaner to operate in a repositioning mode, optionally with the suction members 510b adjusted to an anchor condition, to reposition the arms 545. The arms and corresponding suction members may be used to push or pull the body 508 in a particular direction.

FIGS. 5C-5E illustrate an example sequence of operations that may be performed by a surface cleaner 100 that includes a set of extendible arms 545. The surface cleaner can be configured to operate in an anchored cleaning mode with the suction members 510a maintained in an anchor condition as shown in FIG. 5C. The suction members 510b on the main body 508 can be maintained in the release condition to allow the main body 508 to move relative to the surface 105. The main body 508 can then perform a cleaning operation while travelling along the surface 105 to the position shown in FIG. 5D (forwardly to the right as exemplified).

Once the cleaning operation has been completed, the suction member(s) 510a on arms 545 can be adjusted to the release condition and the suction members 510b can be adjusted to an anchor condition as shown in FIG. 5E. The surface cleaner 100 can then operate in a repositioning mode and retract the arms 545 to the first position as shown in FIG. 5F. The surface cleaner 100 shown in FIGS. 5A-5E can be configured to operate sequentially in the anchored cleaning mode and repositioning mode, for example by repeating the sequence of operations shown in FIGS. 5C-5F to perform an iterative cleaning process.

The sequence of operations shown in FIGS. 5C-5E illustrate an example of a push anchored cleaning mode in which the arms 545 are maintained in a fixed position and the main body 508 pushes away from the fixed position (i.e, the arms extend) while the cleaning operation is performed. It will be appreciated that a pull anchored cleaning mode could be performed in a similar manner, with the arms 545 maintained in a fixed position relative to the surface 105 while in an extended position and the main body 508 pulls towards the fixed position (i.e, the arms retract) while the cleaning operation is performed. In such a configuration, when the surface cleaner 100 operates in a repositioning mode, the arms 545 may be extended away from the main body 508 to a new fixed position in order to adjust to the anchored cleaning mode. For example, extension of the arms 545 may be driven by a drive mechanism such as a pneumatic actuator or linear actuator.

Optionally, a mobile cleaning section (such as mobile cleaning sections 218, 318 and 408b) may omit any suction members. In such cases, the main body 108 may reposition itself as needed and adjust the position of the mobile cleaning section to return to a cleaning start position as required.

Surface Cleaner with Stain Detection Sensor(s)

The following is a description of a robotic surface cleaner operable with one or more stain detection sensors. It will be appreciated that the features of the robotic surface cleaner operable with one or more stain detection sensors may be used alone or in combination with various other features of an autonomous surface cleaner described herein, such as a robotic surface cleaner having one or more suction members, a robotic surface cleaner operable in one or more operational modes, a robotic surface cleaner with a mobile cleaning section, a robotic surface cleaner operable with one or more fluid dispensers, a robotic surface cleaner operable with one or more disinfectant members, a robotic surface cleaner having a carpet cleaning suction member, a robotic surface cleaner having a suction member cleaning unit, and a surface cleaning method.

The robotic surface cleaner can perform cleaning operations on unclean surface regions in response to the detection of stains by the stain detection sensors. The following description contains various features which may be used individually or in any combination or sub-combination.

One or more stain detection sensors can be configured to detect an unclean surface region to be cleaned by the robotic surface cleaner 100. Each stain detection sensor can generate a stain detection signal when an unclean surface region is detected. As used herein a stain detection signal may refer more generally to a signal indicative of an unclean surface region to be cleaned and/or a command signal of a particular surface region to be cleaned.

The stain detection signal can be received by the controller of the surface cleaner 100. In response to receiving a stain detection signal, the controller can then control the operation of the surface cleaner 100 to drive the vacuum cleaner to an anchor position (e.g. using the floor engaging members 140) in which the surface cleaner 100 overlies at least a portion of the unclean surface region. The surface cleaner 100 may be moved to the desired location and clean the desired location using any method disclosed herein.

The stain detection signal can enable the surface cleaner 100 to clean a specific unclean or stained region of the surface 105 without requiring the surface cleaner to conduct a search pattern along the surface 105.

The surface cleaner 100 can then operate one or more cleaning members to clean the portion of the unclean surface region while in the anchor position. For example, the surface cleaner 100 may operate in a spot cleaning mode in response to the stain detection signal.

The spot cleaning mode may include to a modified version of a cleaning mode that includes the anchored cleaning mode and repositioning mode described herein above. In the spot cleaning mode, the surface cleaner may reposition itself in an anchor position in response to the stain detection signal. Once at the anchor position, the surface cleaner can adjust to an anchored cleaning mode in which at least one suction members is secured to the surface 105 in the anchor condition. The surface cleaner can then operate at least one cleaning to clean the unclean surface region with the at least one suction members secured to the surface 105.

The surface cleaner 100 can operate in various cleaning modes to perform cleaning operations at the unclean surface region. For example, the stain detection signal may indicate an unclean surface region that requires the surface cleaner 100 to position itself in multiple anchor positions to clean the unclean surface region in an anchored cleaning mode and/or perform cleaning operations while in a mobile cleaning.

Various types of stain detection sensors can be used to identify an unclean surface region. Optionally, an optical sensor may be used as a stain detection sensor. The optical sensor may be a color sensor and/or an ultraviolet detector operable to detect an unclean surface region. The optical sensor may also include an image or video camera operable to obtain an image of a potential region to be cleaned. The sensor data from the stain detection sensor can be processed to identify the unclean surface region. For instance, an unclean surface region may be detected based on changes in the color or ultraviolet light detected on the surface.

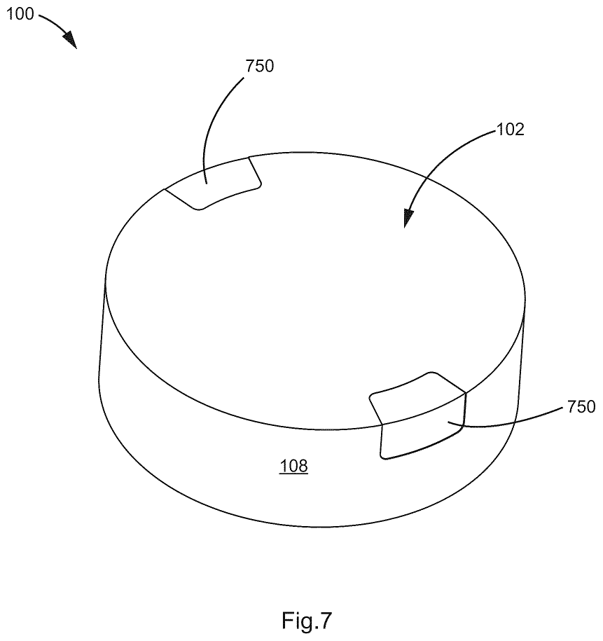

Optionally, a robotic surface cleaner 100 can include one or more stain detection sensors 750 as shown in the example of FIG. 7. In the example shown in FIG. 7, stain detection sensors 750 are provided on the body 108 of the surface cleaner 100.

The stain detection sensor(s) 750 can be arranged on the body 108 of the surface cleaner 100 to collect data from the surface 105 in the vicinity of the surface cleaner 100. The stain detection sensor(s) 750 can be configured to detect an unclean surface region and generate a stain detection signal in response to detecting the unclean surface region. The stain detection signal may then be provided to a controller onboard the surface cleaner 100 to cause the surface cleaner 100 to travel to the unclean surface region and perform a cleaning operation.

Optionally, the stain detection signal may be received by the surface cleaner 100 from a remote computing device in communication with the controller of the surface cleaner 100. For example, the stain detection signal may be received from a user device having a surface cleaning application operating thereon.

The surface cleaning application can be configured to transmit the stain detection signal to the surface cleaner 100 in response to the identification of the location of an unclean surface region by the user device. The location of the unclean surface region can be identified based on sensor data obtained by the user device. For example, the user device can include a sensor (e.g. an optical sensor such as a camera) that is operable to detect an unclean surface region. The location of the unclean surface region may be determined based on image data captured by the remote computing device of the unclean surface region.

The stain detection signal transmitted to the surface cleaner can include stain coordinates for the unclean surface region to enable the surface cleaner to navigate to the unclean surface region. The controller of the surface cleaner 100 can be configured to drive the surface cleaner 100 to the unclean surface region using the stain coordinates.

Optionally, the stain coordinates can be defined as absolute stain coordinates based on an absolute position of the unclean surface region.

Alternatively, the stain coordinates can be defined as relative stain coordinates based on a relative position of the unclean surface region to a known location, such as the user device and/or a fixed reference point. The fixed reference point can be defined based on a fixed point within the location being cleaned, such as a base station for the surface cleaner. For example, the stain coordinates may be defined as relative base coordinates indicating a relative position of a surface cleaner base station to the unclean surface region.

Optionally, the stain detection signal may be user-generated. For example, a user may provide an input to the surface cleaning application identifying a particular surface region as being an unclean surface region. The surface cleaning application can then generate a stain detection signal for that particular surface region that can be transmitted to the surface cleaner 100.

Optionally, the stain detection signal can be generated in response to image data captured by the remote device indicating the unclean surface region. The unclean surface region within the image data may be identified manually by a user interacting with the surface cleaning application. Alternatively or in addition, the unclean surface region may be identified automatically by the computing device, for instance based on processing and analysis of the image data captured by the remote computing device.

Surface Leaner with Cleaning Fluid Dispenser

The following is a description of a robotic surface cleaner operable with one or more fluid dispensers. It will be appreciated that the features of a robotic surface cleaner operable with one or more fluid dispensers may be used alone or in combination with various other features of an autonomous surface cleaner described herein, such as a robotic surface cleaner having one or more suction members, a robotic surface cleaner operable in one or more operational modes, a robotic surface cleaner with a mobile cleaning section, a robotic surface cleaner operable with one or more stain detection sensors, a robotic surface cleaner operable with one or more disinfectant members, a robotic surface cleaner having a carpet cleaning suction member, a robotic surface cleaner having a suction member cleaning unit, and a surface cleaning method.

The robotic surface cleaner can operate the fluid dispensers to assist in performing cleaning operations on unclean surface regions. The fluid dispensers can also be used to enhance the seal between one or more suction members and the underlying surface. The following description contains various features which may be used individually or in any combination or sub-combination.

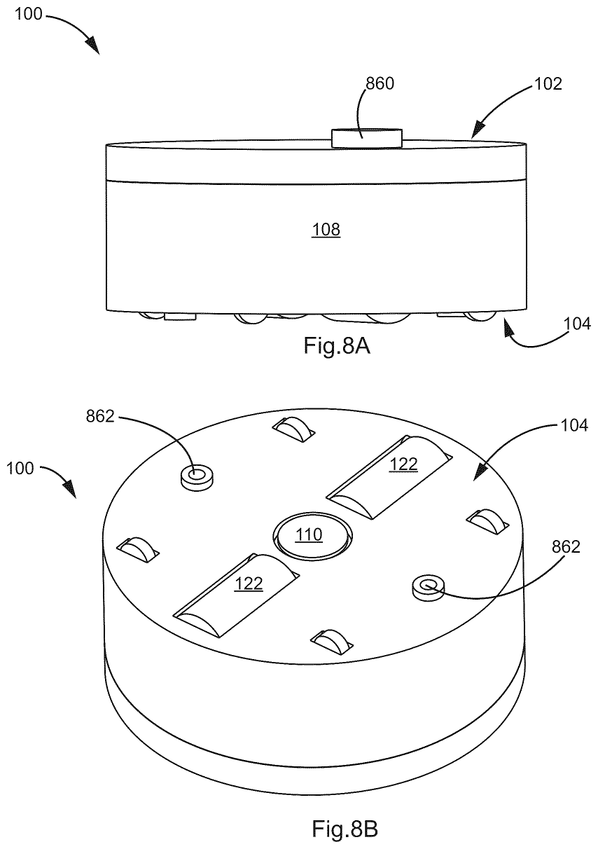

Referring to FIGS. 8A and 8B, shown therein is an example of a surface cleaner 100 that includes a fluid dispenser 862. The surface cleaner can include one or more fluid dispensers 862 operable to dispense a fluid onto a surface 105 being cleaned by the surface cleaner 100.

The surface cleaner 100 can include a fluid reservoir 860 that can hold fluid to be dispensed by the dispensers 862. The fluid reservoir 860 can be refillable by a user, for instance by removing a door or lid of the reservoir 860 and adding additional fluid into the reservoir. The reservoir may be removable for filling.

Optionally, the fluid dispensers 862 can be configured to dispense a cleaning fluid to assist cleaning operations performed by the surface cleaner 100. The fluid dispensers 862 can be operated to dispense cleaning fluid onto an unclean surface region prior to operating at least one cleaning member 122 to clean the unclean surface region.

Optionally, the fluid dispensers 862 can be arranged to dispense the cleaning fluid such that the cleaning fluid is at least partially aligned with a portion of the surface 105 over which the cleaning member 122 will travel when performing cleaning operations. For instance, the fluid dispensers 862 may be radially aligned with the cleaning members 122 (e.g. as shown in FIG. 8B) if the cleaning members travel in a circular path to perform cleaning operations.

It will be appreciated that, depending on the path along which the cleaning members 122 travel, the alignment of the fluid dispensers and cleaning members 122 may differ, and/or may be omitted (e.g. where the fluid dispensers are configured to dispense fluid across an entire surface and the surface cleaner 100 is similarly configured to travel a path that enables the cleaning members 122 to clean the entire surface).

Optionally, the fluid dispensers 862 can be configured to dispense a suction-assisting fluid to assist in establishing and maintaining a seal between a suction member of the surface cleaner 100 and an underlying surface 105. Optionally, the suction-assisting fluid and cleaning fluid may be the same. Alternatively, the suction-assisting fluid may be different from the cleaning fluid.

Optionally, the same fluid dispenser(s) 862 may be used to dispense a suction-assisting fluid and a cleaning fluid. The fluid dispenser(s) 862 may be coupled to different fluid reservoirs 860 in cases in which the suction-assisting fluid and cleaning fluid are different.

Alternatively, different fluid dispenser(s) 862 may be used to dispense the suction-assisting fluid and cleaning fluid. In such cases, the cleaning fluid dispenser can be coupled to a cleaning fluid reservoir and the suction-assisting fluid dispenser may be coupled to a separate suction-assisting fluid reservoir.

The suction-assisting fluid may be particularly useful for maintaining suction between a suction member and an uneven surface portion. The surface cleaner 100 can be driven to a first position overlying the surface to be cleaned. To perform anchored cleaning operations at the first position, the surface cleaner 100 may adjust one or more suctions members to an anchor condition while overlying the first position.

Prior to transitioning the suction members to the anchor condition, the surface cleaner 100 and/or a remote user device can determine that the first position is or includes an uneven surface portion. That is, the surface cleaner 100 and/or a remote user device may determine that the one or more suctions members may engage with the uneven surface portion when transitioning to the anchor condition. The identification of the uneven surface portion may be based on sensor data from the surface cleaner 100 and/or a remote user device, such as image data and/or tilt sensors or other pose sensors onboard the surface cleaner 100 usable to determine that the underlying surface is uneven at the first position.

In response to determining that the first position overlies an uneven surface portion, the surface cleaner 100 can apply a fluid (e.g. a suction-assisting fluid) to the uneven surface portion prior to applying the at least one suction member to the surface. The fluid can be selected and applied to improve the suction force applied by the at least one suction member, for instance by improving the consistency of the seal between the suction member and the surface.

Optionally, the fluid dispensers 862 can be arranged to dispense the suction-assisting fluid such that the fluid is aligned with the portion of the surface 105 to which the suction member(s) 110 will be anchored. For instance, the fluid dispensers 862 may be radially aligned with the suctions member(s) 110 where the surface cleaner is rotatable about a central axis such as the fluid can be dispensed and then the surface cleaner 100 can rotate to align the suction members 110 with the fluid location.

It will be appreciated that, depending on the path along which the suctions member(s) 110 can travel, the alignment of the fluid dispensers and suctions member(s) 110 may differ, and/or may be omitted.

Surface Cleaner with Disinfectant Member

The following is a description of a robotic surface cleaner operable with one or more disinfectant members. It will be appreciated that the features of the robotic surface cleaner operable with one or more disinfectant members may be used alone or in combination with various other features of an autonomous surface cleaner described herein, such as a robotic surface cleaner having one or more suction members, a robotic surface cleaner operable in one or more operational modes, a robotic surface cleaner with a mobile cleaning section, a robotic surface cleaner operable with one or more stain detection sensors, a robotic surface cleaner operable with one or more fluid dispensers, a robotic surface cleaner having a carpet cleaning suction member, a robotic surface cleaner having a suction member cleaning unit, and a surface cleaning method.

The robotic surface cleaner can operate the disinfectant members to disinfect surface regions while performing cleaning operations. The following description contains various features which may be used individually or in any combination or sub-combination.

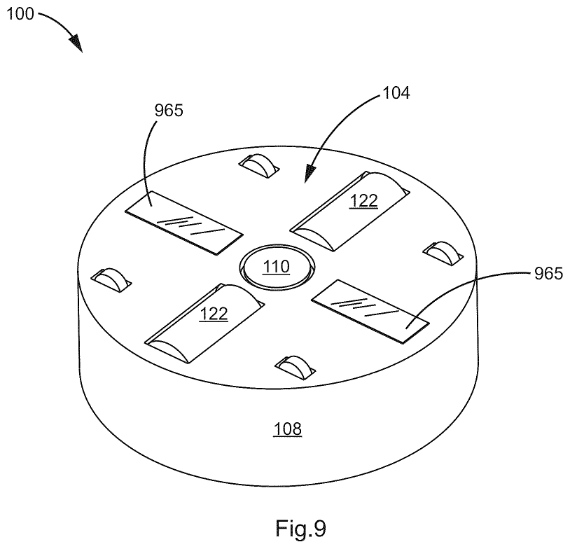

FIG. 9 shows an example surface cleaner 100 that includes a disinfectant member operable to disinfect a surface being clean. In the example shown in FIG. 9, the disinfectant member includes an ultraviolet light source 965 provided on the body 108 of the surface cleaner. The ultraviolet light source 965 can be used to disinfect a surface by directing ultraviolet light at the surface. Optionally, the surface cleaner 100 can include a plurality of disinfectant members, such as the example pair of ultraviolet light emitters 965 shown in FIG. 9.

As shown in FIG. 9, a disinfectant member 965 can be provided on the underside 104 of the main body 108. Alternatively or in addition, a disinfectant member 965 may be provided at other portions of the surface cleaner 100, such as a side of the body 108 and/or a mobile cleaning section.

The surface cleaner 100 can also include one or more cleaning members 122 in addition to the disinfectant member 965. The cleaning members 122 and disinfectant member(s) 965 can cooperate to clean and disinfect a surface while performing cleaning operations thereon. As will be appreciated, the surface cleaner 100 may also include various other types of cleaning members 120 and/or related components, such as a dirt inlet or fluid dispenser for example or any other component disclosed herein.

Optionally, the disinfectant member(s) 965 and cleaning members 122 can be aligned on the surface cleaner 100 such that the surface region that is cleaned by the cleaning members 122 is also disinfected by operation of the disinfectant member(s) 965. The disinfectant member(s) 965 and cleaning members 122 may be aligned to enable the same underlying surface to be cleaned while the surface cleaner 100 operates in an anchored cleaning mode. For example, the disinfectant member(s) 965 may be radially aligned with the cleaning members 122 if the surface cleaner 100 is rotatable about a central axis, such as rotatable about a central suction member 110 as shown in the example of FIG. 9. Alternatively, the disinfectant member(s) 965 may be linearly aligned with the cleaning members 122 if the cleaning member(s) 122 travel in a linear direction, for example as part of a mobile cleaning section or when a translatable cleaning member is provided.

It will be appreciated that, depending on the path along which the cleaning members 122 can travel while performing cleaning operations, the alignment of the disinfectant member(s) 965 and cleaning members 122 may differ, and/or may be omitted.

Optionally, the disinfectant member(s) may have a range of operation that can be controlled by the controller of the surface cleaner 100 to disinfect a desired region of the surface (e.g. in alignment with the region cleaned by the cleaning members 122).

Surface Cleaner with Carpet Cleaning Suction Member

The following is a description of a robotic surface cleaner having a carpet cleaning suction member. It will be appreciated that the features of the robotic surface cleaner having a carpet cleaning suction member may be used alone or in combination with various other features of an autonomous surface cleaner described herein, such as a robotic surface cleaner having one or more suction members, a robotic surface cleaner operable in one or more operational modes, a robotic surface cleaner with a mobile cleaning section, a robotic surface cleaner operable with one or more stain detection sensors, a robotic surface cleaner operable with one or more fluid dispensers, a robotic surface cleaner operable with one or more disinfectant members, a robotic surface cleaner having a suction member cleaning unit, and a surface cleaning method.

The carpet cleaning suction system can be used to maintain contact between the robotic surface cleaner and an irregular surface such as a carpet underlying the robotic surface cleaner. The carpet cleaning suction system can improve the seal between a suction member and the underlying irregular surface to allow the surface cleaner to clean the irregular surface with the suction member anchored to the surface. The following description contains various features which may be used individually or in any combination or sub-combination.

As described herein above, a mobile surface cleaner 100 which is operable to clean a carpet may be referred to as a robotic carpet cleaner or robotic extractor, and may be provided with at least one suction member 110 attached to a mobile body 108. The mobile body 108 can also include at least one cleaning member 122 that can be positioned on the underside 104 of the base 108. The suction member 110 can be configured to engage a surface below the body 108 and apply a suction force to secure the suction member 110 to the surface. The suction force can also maintain the cleaning member 122 in position to contact the surface. The suction member 110 can thus anchor the surface cleaner 100 in position on the underlying surface to facilitate and/or improve cleaning operations.

When the surface cleaner 100 is positioned on an uneven surface such as carpet, this can inhibit the formation of a seal between the suction member 110 and the surface and/or increase the suction force required to secure the suction member 110 to the surface. Accordingly, the surface cleaner 100 may be provided with a seal-enhancement member that can assist in establishing and/or maintaining the seal between the suction member 110 and the surface.

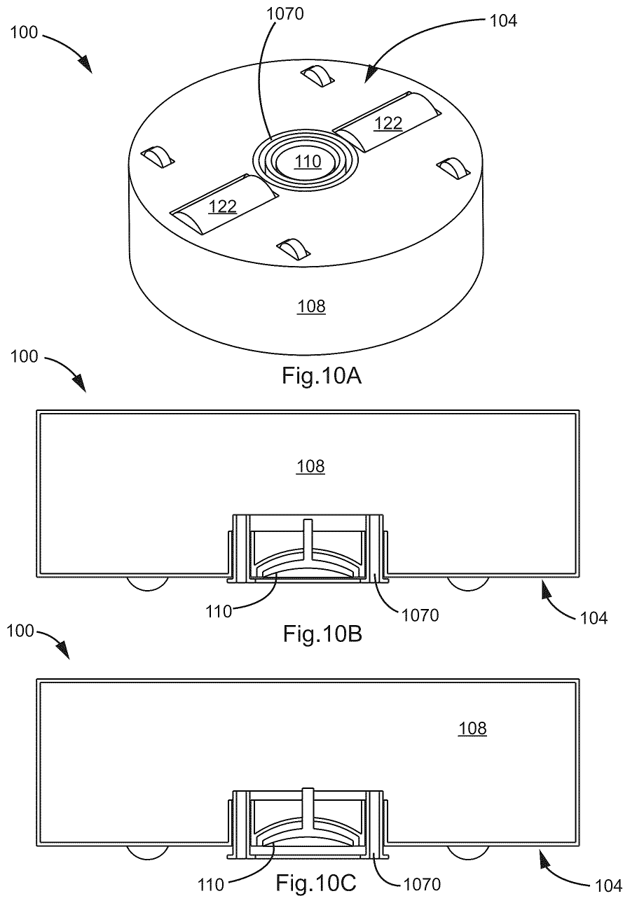

FIGS. 10A-10C illustrate an example of a surface cleaner 100 that includes a seal-enhancement member. In the example shown in FIGS. 10A-10C, the seal-enhancement member is provided in the form of an expandable sealing member 1070. As illustrated, the sealing member 1070 is shaped and positioned to surround the suction member 110. The sealing member 1070 can be adjusted to an in-use position (e.g. as shown in FIG. 10C) in which the sealing member 1070 provides a sealed or semi-sealed volume around the suction member 110 to assist the suction member 110 in maintaining its engagement with the underlying surface.

The sealing member 1070 can be adjusted between a storage position (e.g. as shown in FIG. 10B) and an in-use position (e.g. as shown in FIG. 10C). In the in-use position, the sealing member 1070 can extend downward from the underside 104 of the base 108 to contact and engage an underlying surface 105. The sealing member 1070 can surround the suction member 110 when it is in an anchor condition also engaged with the surface 105. In the storage position, the sealing member 1070 can be retracted relative to the in-use position. Optionally, the sealing member 1070 may be retracted to a storage position that is partially or wholly nested within the body 108 (or at least partially or wholly raised to a level above the underside 104).

Optionally, the sealing member 1070 can be provided in the form of an inflatable cuff shaped and positioned to surround the suction member 110. For example, the sealing member 1070 can be an inflatable ring that is positioned around the suction member 110. The inflatable cuff can be inflated to an inflated condition to thereby transition the sealing member 1070 to the in-use position. In the inflated condition, the inflated cuff can provide a semi-sealed volume around the suction member 110. The inflatable cuff can subsequently be deflated to transition the sealing member 1070 to a storage position.

Optionally, the surface cleaner 100 may be operable in a carpet cleaning mode. In the carpet cleaning mode, the controller of the surface cleaner 100 can control the operation of the sealing member 1070 to assist in establishing and/or maintaining engagement between the suction member 110 and the underlying surface. In the carpet cleaning mode, the inflatable cuff can be adjusted to an inflated condition and the at least one suction member 110 can be maintained in the anchor condition to enable the surface cleaner to perform anchored cleaning operations on the surface below.

Optionally, the carpet cleaning mode can be activated manually by a user (e.g. interacting with a user interface of the surface cleaner 100 and/or a user device). Alternatively or in addition, the carpet cleaning mode can be activated automatically by the controller of the surface cleaner 100 in response to the detection of an underlying carpet surface and/or uneven surface portion.

Optionally, the sealing member 1070 may be activated only when the surface cleaner 100 operates in the carpet cleaning mode. This may help reduce energy consumption by the surface cleaner 100 when operating on other surfaces and/or when operating on even surface regions.

Optionally, the surface cleaner 100 can include a suction motor that is operable to establish and/or enhance the suction force between the suction member 110 and the underlying surface. In the carpet cleaning mode, the suction motor can be used to establish the suction force between the suction member 110 and the surface.

Optionally, the suction motor may be activated to establish and/or enhance the suction force between the suction member 110 and the underlying surface only when the surface cleaner 100 operates in the carpet cleaning mode.

Alternatively or in addition, the suction motor can be used to establish and/or enhance the suction force within the volume around the suction member 110 defined by the sealing member 1070. That is, the sealing member 1070 and suction motor can cooperate to establish a separate suction seal that is surrounding the suction member 110 and thereby reinforce and enhance the suction force securing the suction member 110 to the underlying surface.

Optionally, the suction motor may be activated to establish and/or enhance the suction force between the sealing member 1070 and the underlying surface only when the surface cleaner 100 operates in the carpet cleaning mode.

Surface Cleaner with Suction Member Cleaning Unit

The following is a description of a robotic surface cleaner having a suction member cleaning unit. It will be appreciated that the features of the robotic surface cleaner having a suction member cleaning unit may be used alone or in combination with various other features of an autonomous surface cleaner described herein, such as a robotic surface cleaner having one or more suction members, a robotic surface cleaner operable in one or more operational modes, a robotic surface cleaner with a mobile cleaning section, a robotic surface cleaner operable with one or more stain detection sensors, a robotic surface cleaner operable with one or more fluid dispensers, a robotic surface cleaner operable with one or more disinfectant members, a robotic surface cleaner having a carpet cleaning suction member, and a surface cleaning method.

As described herein above, a surface cleaner 100 can be provided with one or more suction members 110 that can be used to secure the surface cleaner 100 (or a portion thereof) in a fixed position overlying a surface. However, the capability of the suction member 110 to establish a seal with the underlying surface (and the effectiveness of the seal once established) can be inhibited by dirt or debris that can build up on the surface of the suction member 110. This may prevent the surface cleaner 100 from being able to operate effectively in an anchored cleaning mode.

The suction member cleaning unit can be used to clean a surface contacting portion of a suction member to remove build-up of dirt and debris and ensure that the suction member can establish a better seal with the underlying surface. The following description contains various features which may be used individually or in any combination or sub-combination.

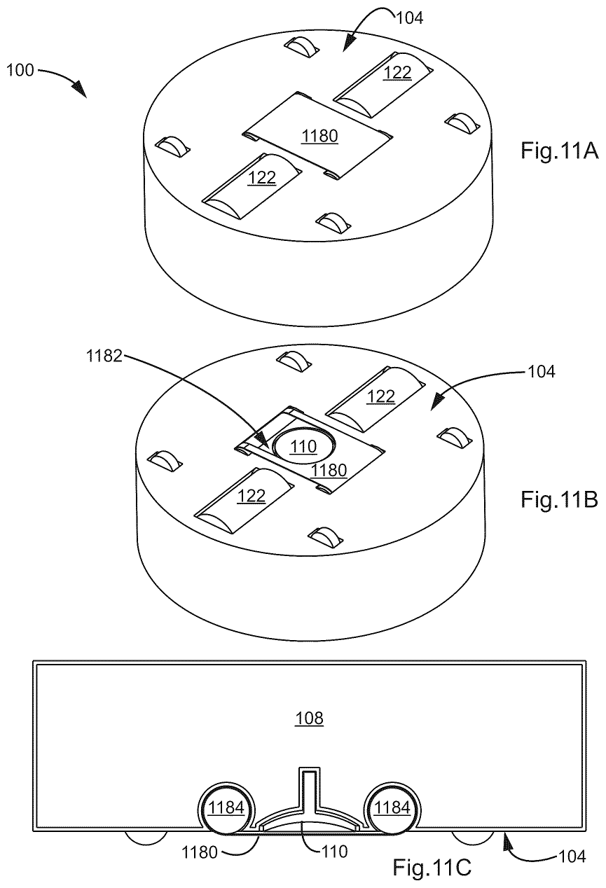

FIGS. 11A-11C illustrate an example of a robotic surface cleaner 100 that includes a suction member cleaning unit. As shown in FIGS. 11B and 11C, the base 108 of the surface cleaner 100 can have at least one suction member 110 attached thereto. The suction member cleaning unit can be configured to clean the lower surface of the suction member 110 (i.e, the surface of the suction member 110 that engages with the underlying surface to be cleaned).

The suction member cleaning unit can be operated to clean the suction member 110 while the suction member 110 is in the release condition. In the example illustrated, the suction member 110 can be adjusted to a retracted position prior to being cleaned by the suction member cleaning unit 1180.

The suction member 110 may be cleanable while the surface cleaner 100 is in operation. For example, the suction member 110 may be cleaned following a transition to the release condition. Optionally, the suction member 110 may be cleaned each time it transitions to a release condition. Alternatively, the suction member 110 may be cleaned at regular intervals (e.g. following a specified number of times being adjusted to an anchor condition) and/or in response to a control signal indicating that cleaning is required. The control signal may be input manually by a user or generated by the controller automatically, e.g. in response to determining that the effectiveness of the suction member 110 has decreased.

The surface cleaner 100 shown in FIGS. 11A-11C includes only a single suction member 110 and a corresponding suction member cleaning unit 1180. A surface cleaner 100 with a plurality of suction members 110 can include one or more suction member cleaning units operable to clean each suction member while that suction member is in the release condition.

The suction member cleaning unit can also be configured to permit the suction member 110 to be adjusted to the anchor condition as required by operation of the surface cleaner 100. For example, the suction member cleaning unit 1180 may adjustable between a cleaning condition and an open condition. In the cleaning condition, the suction member cleaning unit 1180 can be positioned to contact and clean the lower surface of the suction member 110.

In the open condition, the suction member cleaning unit 1180 can be positioned to permit the suction member 110 to be adjusted to the anchor condition. In the example illustrated, the suction member cleaning unit 1180 can allow the suction member 110 to adjust between an extended position and a retracted position while the suction member cleaning unit 1180 is in the open condition.

Optionally, the suction member cleaning unit 1180 can include an aperture or opening 1182 to allow the suction member 110 to extend through a portion of the suction member cleaning unit 1180. The suction member cleaning unit 1180 can be adjusted to the open position by positioning the aperture or opening 1182 in alignment with the suction member 110. This can allow the suction member cleaning unit 1180 to remain in a fixed position while permitting the suction member 110 to freely be adjusted between the anchor condition and release condition.

Alternatively, the suction member cleaning unit 1180 may be translatable between a cleaning condition underlying the suction member 110 and an open condition where the suction member cleaning unit 1180 is displaced (translated, rotated, etc.) from the suction member 110 (i.e. does not underlie the suction member 110).

A suction member cleaning unit 1180 can be provided using various types of cleaning members. For example, the cleaning members can be provided using various cleaning materials such as cloth, plastic, or rubber for example. The cleaning members can be provided using flexible cleaning materials to facilitate cleaning a non-planar lower surface of a suction member 110. The cleaning members can be operated to clean the lower surface of the suction member 110 by travelling over/along the lower surface.

The cleaning members can be provided in various forms, such as a wiper, a roll of cleaning material, a cleaning pad, etc. For example, a wiper or cleaning pad can be translated across the lower surface of the suction member 110 to clean the corresponding suction member 110. The cleaning member may be dry or provided with a liquid to assist in the cleaning operation.

In the example illustrated, the cleaning member for the suction member cleaning unit 1180 is provided as a roll of cleaning material. Optionally, the roll of cleaning material may be a windable roll that can be wound around a first roller end 1184. The roll can be unwound to travel along the lower surface of the suction member 110 and then wound around a second roller end 1184. Optionally, the process of winding and unwinding the roll around the roller ends 1184 can be repeated in both directions to permit subsequent/further cleaning of the suction member 110.

Optionally, the roll of cleaning material may be a continuous roll. The continuous roll of cleaning material can be looped around to clean the suction member 110, in some cases permitting the same section of cleaning material to be used multiple times to clean the suction member 110.

As shown in FIG. 11B, a roll of cleaning material can be provided with one or more openings 1182 through the cleaning material. This can allow the suction member 110 to freely transition between an anchor condition and release condition while the roll of cleaning material remains underlying the suction member 110.

Optionally, the cleaning member may be a disposable cleaning member. The disposable cleaning member may be used to clean the lower surface of a suction member 110 a limited number of times before needing to be replaced by a new disposable cleaning member. For example, the roll of cleaning material may be a roll of disposable cleaning material. Once a roll has become dirty, a new roll of cleaning material can be inserted into the suction member cleaning unit to allow the suction member 110 to continue to be cleaned.

Alternatively, the cleaning member may be a reusable cleaning member. This may facilitate ongoing cleaning of the suction member 110 without requiring the user to replace the cleaning member.

A reusable cleaning member can become dirty due to repeatedly cleaning the suction member 110. Thus, the reusable cleaning member may be cleanable to ensure its continued effectiveness.

Optionally, the cleaning member may be cleaned after each time it is used to clean the corresponding suction member 110.

Alternatively, the cleaning member may be cleaned intermittently, for instance at regular intervals (e.g. following a specified number of cleaning operations) and/or in response to a control signal indicating that cleaning of the cleaning member is required. The control signal may be input manually by a user or generated by the controller automatically, e.g. in response to detecting that the cleaning member is dirty.

Optionally, the cleaning member may be cleanable onboard the surface cleaner 100. The cleaning member may be cleaned while the surface cleaner 100 remains operational, for instance when the corresponding suction member is in an anchor condition or following cleaning of the suction member while the suction member is still in a release condition. This can help prolong the effective operational period for the surface cleaner 100.

For instance, the suction member cleaning unit may include an onboard cleaning system for cleaning the cleaning member following its use to clean the suction member. Optionally, the onboard cleaning system may be at least partially integrated with the surface cleaner cleaning system (e.g. making use of the same dirt container and/or suction motor and fan assembly). The onboard cleaning system may include a suction cleaning system and/or an abrasive cleaning element to remove dirt and debris from the cleaning member.

Alternatively, the cleaning member may be cleanable at a surface cleaner base or docking station. The cleaning member can be cleaned while the surface cleaner is positioned at the docking station (e.g. to recharge an onboard energy storage member). This may provide a regular cleaning interval for the cleaning members while permitting the surface cleaner to omit an onboard cleaning system.

Alternatively or in addition, the cleaning member may be manually cleanable by a user of the surface cleaner 100.

In the example illustrated in FIGS. 11A-11C, the suction member 110 is cleanable onboard the surface cleaner 100. This can help prolong the effective operational time for the surface cleaner 100 without requiring the surface cleaner to return to its base or docking station.

Alternatively or in addition, the suction member 110 may be cleanable at a surface cleaner base station. In such cases, the base station can include the surface member cleaning unit. This can facilitate the provision, cleaning, and maintenance of the surface member cleaning unit. This may also allow the surface cleaner to omit an onboard surface member cleaning unit. Omitting an onboard surface member cleaning unit can reduce the size of the surface cleaner 100 and prevent the cleaning unit from interfering with cleaning operations.

The suction member cleaning unit provided at a base station can be operated to clean the suction member 110 while the suction member 110 is in the release condition. Alternatively, the suction member cleaning unit provided by a base station may clean a suction member 110 when it is adjusted to an anchor condition. This may facilitate access to the lower surface of the suction member 110 by the base station surface member cleaning unit.

### Surface Cleaning Method

The following is a description of a surface cleaning method that can be performed by a robotic surface cleaner having one or more suction members. It will be appreciated that the features of the surface cleaning method may be used alone or in combination with various other features of an autonomous surface cleaner described herein, such as a robotic surface cleaner having one or more suction members, a robotic surface cleaner operable in one or more operational modes, a robotic surface cleaner with a mobile cleaning section, a robotic surface cleaner operable with one or more stain detection sensors, a robotic surface cleaner operable with one or more fluid dispensers, a robotic surface cleaner operable with one or more disinfectant members, a robotic surface cleaner having a carpet cleaning suction member, and a robotic surface cleaner having a suction member cleaning unit.

The following description contains various features which may be used individually or in any combination or sub-combination.

A surface cleaner 100 with one or more suction members 110 can be used to perform various cleaning operations while the suction member(s) 110 maintain the surface cleaner 100 in a desired position. The surface cleaner 100 can clean multiple sections of a surface by iteratively moving to a new position, securing at least one suction member 110 to the surface, and cleaning the surface while maintained in position by the suction member 110.

For example, the surface cleaner can be operated to clean a (first section of the) surface while the surface cleaner is maintained in a first position overlying the surface by the at least one suction member 110. The surface cleaner can clean the surface while operating in an anchored cleaning mode such as the example anchored cleaning modes described herein above.

The surface cleaner may be secured in the first position by using the at least one suction member to engage a surface underneath the surface cleaner and to apply a suction force to secure the at least one suction member to the surface. Optionally, maintaining the surface cleaner in the first position can include a suction motor to intermittently or continuously apply a motorized suction force between the at least one suction member and the surface. Intermittently or continuously applying suction can help ensure that the seal between the suction member and the surface remains strong.

Alternately, or in addition, a fluid can be applied to the surface prior to applying the at least one suction member to the surface. This may help improve the suction force applied by the at least one suction member.

The surface cleaner 100 can subsequently be moved to a second position overlying the surface. Optionally, the at least one suction member can be disengaged from the surface prior to moving the surface cleaner to the second position. Further optionally, all of the suction members can be disengaged from the surface prior to moving the surface cleaner to the second position. In such a case, the surface cleaning includes a drive member such as a drive motor drivingly connected to at least one wheel or a rotatably mounted cleaning brush that can provide motive force to the surface cleaner.

Alternatively, or in addition, at least one of the suction members can remain secured to the surface while the surface cleaner is moved to the second position.

The surface cleaner 100 can then be operated to clean (a second section of) the surface while the surface cleaner 100 is maintained in the second position by the at least one suction member 110.

For an entire surface area to be cleaned, the steps of moving the surface cleaner 100 to a position overlying the surface and operating the surface cleaner 100 to clean the surface while the surface cleaner 100 is maintained in the position by the at least one suction member can be repeated. The process may be initiated by positioning the surface cleaner in the first position and then cleaning the surface while the surface cleaner is maintained in the first position.

This iterative process can ensure that the entire surface area is cleaned (since the surface cleaner is maintained in positions across the entire surface area). This may also provide a deeper clean for the entire surface area, by increasing the downforce on the surface cleaner when performing cleaning operations.

The surface cleaner 100 can perform various cleaning functions. Optionally, operating the surface cleaner 100 to clean the surface can include operating a surface cleaning member to agitate the surface. For example, a cleaning brush or cleaning pad can be used to agitate the surface.

Alternatively or in addition, operating the surface cleaner as a vacuum cleaner to clean the surface can include operating a suction fan to entrain dirt and debris into a dirty air inlet of the surface cleaner.

Optionally, operating the surface cleaner to clean the surface may include dispensing a cleaning fluid onto the surface. The cleaning fluid may be dispensed onto the surface prior to, or in combination with, operation of a surface cleaning member 120 to agitate the surface.

Optionally, operating the surface cleaner to clean the surface may include disinfecting the surface. Disinfecting the surface can be performed by operating a disinfectant member of the surface cleaner, such as an ultraviolet light for example.

Optionally, the surface cleaner 100 can remain fixed while being maintained in a position to clean the surface. Operating the surface cleaner to clean the surface may include operating a movable cleaning member to clean the surface area at the first position.

Alternatively, the surface cleaner 100 or a portion thereof may be movable while maintained in an anchor position. For example, the surface cleaner may be rotated while the surface cleaner is maintained in the first position.

Optionally, the position(s) where cleaning is to be performed can be identified prior to moving the surface cleaner to those positions. For example, the first position or second position can be identified as an anchor position within a surface area to be cleaned. The surface cleaner can be moved to the first position or second position in response to identifying the anchor position.

An anchor position can be identified as a desired location to position the surface cleaner to perform a cleaning operation on the underlying surface. For example, the anchor position can be identified by detecting an unclean surface region. The unclean surface region may be identified using an onboard sensor and/or based on data received from a remote device such as a user device. The anchor position can then be defined such that the surface cleaner 100 overlies at least a portion of the unclean surface region when moved to the anchor position. This can ensure that the surface cleaner 100 is positioned to clean the unclean surface region.

Alternatively or in addition, an anchor position can be identified based on a cleaning map or pattern. A cleaning pattern can define a set or sequence of anchor positions to be cleaned by the surface cleaner. The surface cleaner may be moved to each of the anchor positions within the set of anchor positions. Optionally, the surface cleaner can be moved to each of the anchor positions in an anchor position order defined by the set of anchor positions.

Optionally, the cleaning pattern may be a predefined or default cleaning pattern. For example, the cleaning pattern can be defined using a standardized search pattern that can enable the surface cleaner to clean a known or unknown surface area.

Alternatively or in addition, the cleaning pattern may be a location-specific cleaning pattern that is learned or defined for a specific surface area to be cleaned. For example, the location-specific cleaning pattern may be a user-defined cleaning pattern that is input by a user through a user interface of the surface cleaner and/or a user device. The location-specific cleaning pattern may also be learned by the surface cleaner based on mapping the surface area to be cleaned (e.g. using a standardized search pattern).

Optionally, prior to securing the surface cleaner in position, an initial surface cleaning operation can be performed. The surface cleaner can be operated to initially clean a first region of a surface underlying the surface cleaner while the surface cleaner is at a first position overlying the first region. This may help ensure that the suction member can establish an effective seal on the underlying surface section.

The surface cleaner can then be secured in the first position by applying the at least one suction member to the surface within the first region. For example, the surface cleaner can be operated to initially clean an anchor section of the first region. The surface cleaner can then be secured in position by applying the at least one suction member to the anchor section.

The initial cleaning operation can be performed using various types of cleaning functions such as those described herein above. For example, the surface cleaner can be operated to initially clean the first region using suction and/or cleaning member of the surface cleaner. Optionally, operating the surface cleaner to initially clean the first region can include rotating the surface cleaner while the surface cleaner is in the first position. This may allow the cleaning members and/or suction inlet to clean the surface region underlying the suction members 110 without requiring the surface cleaner to be repositioned prior to engaging the suction members 110 with the surface.

Optionally, the anchor position may be determined based (at least in part) on the detection of an uneven surface portion. An uneven surface portion may be detected based on image or other sensor data from the surface cleaner and/or a user device. The anchor position may be selected to avoid positioning the surface cleaner on the uneven surface portion.

Alternatively, the anchor position can be determined to overlie an uneven surface portion. This may be necessary in various cases to ensure that the entire surface area can be cleaned.

Optionally, the surface cleaner can be maintained in position overlying an uneven surface portion using a suction motor to continuously apply a motorized suction force between the at least one suction member and the uneven surface portion. This can also ensure that the suction member remains secured in place even where the underlying surface is uneven.

Alternatively or in addition, a fluid can be applied to the uneven surface portion prior to applying the at least one suction member to the surface to improve the suction force applied by the at least one suction member. The fluid can assist in forming and maintaining a seal between the surface member and the uneven surface portion.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples but should be given the broadest interpretation consistent with the description as a whole.

### Clause Set A

1. A robotic surface cleaner comprising:
   a mobile base that is autonomously movable along an underneath surface;
   at least one cleaning member located on the underside of the base; and
   a first suction member attached to the base, the first suction member being adjustable between an anchor condition and a release condition, in the anchor condition the first suction member engages the surface underneath the base and a suction force secures the suction member to the surface and maintains the cleaning member in position to contact the surface, and in the release condition the mobile base is movable along the underneath surface;
   wherein the surface cleaner is operable in at least one mobile mode in which motion of the cleaning member provides a driving force for the base.
2. The surface cleaner of clause 1, wherein in a mobile cleaning mode, the suction force applied by the suction members is reduced.
3. The surface cleaner of clause 1, wherein in a mobile cleaning mode, the first suction member is maintained in the release condition.
4. The surface cleaner of clause 1, wherein in a mobile cleaning mode, the first suction member is maintained in the anchor condition thereby enabling the base to pivot relative to the surface.
5. The surface cleaner of clause 1, wherein in a mobile cleaning mode, the first suction member is maintained in the anchor condition and the base is rotatable about a rotation axis defined by the at least one suction member.
6. The surface cleaner of clause 5, wherein in the mobile cleaning mode, the base is rotatable about the rotation axis while maintained in a fixed anchor position along the surface.
7. The surface cleaner of clause 1, wherein in a robot translation mode, the first suction member is maintained in the release condition thereby enabling the base to translate relative to the surface.
8. The surface cleaner of clause 1, wherein the at least one cleaning member is located at an inward portion of the base and the at least one suction member is positioned at an outer portion of the base that is outward from the inward portion.
9. The surface cleaner of clause 1, further comprising a plurality of additional suction members arranged along the periphery of the base.
10. The surface cleaner of clause 1, wherein at least two additional suction members are provided.
11. The surface cleaner of clause 1, wherein the surface cleaner is operable in an anchored cleaning mode in which at least one cleaning member is movable relative to the surface to thereby clean the surface while at least one of the suction members is secured to the surface in the anchor condition.
12. The surface cleaner of clause 1, further comprising at least one floor engaging member mounted to the underside of the base, wherein the floor engaging member is operable to drive motion of the base along the surface.
13. The surface cleaner of clause 1, wherein the surface cleaner is operable in a forward motion mode and a reverse motion mode, and the at least one cleaning member rotates in opposite directions in the forward motion mode and the reverse motion mode.
14. The surface cleaner of clause 1, wherein the least one cleaning member comprises a plurality of cleaning members including a first cleaning member and a second cleaning member, and the surface cleaner is operable in a turning mode in which the first cleaning member and second cleaning member rotate in opposite directions whereby a turning force is provided which adjusts a direction of motion of the base.
15. The surface cleaner of clause 1, wherein the at least one suction member comprises a single central suction member enabling the surface cleaner to rotate about a central axis of the base while the central suction member is in the anchor condition.

### Clause Set B

1. A robotic surface cleaner comprising:
   a mobile base that is movable along an underneath surface;
   at least one cleaning member positioned on the underside of the base; and
   a plurality of suction members attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface.
2. The surface cleaner of clause 1, wherein the at least one cleaning member is located at an inward portion of the base and the suction members are positioned at an outer portion of the base that is outward from the inward portion.
3. The surface cleaner of clause 1, wherein the plurality of suction members are arranged along the periphery of the base.
4. The surface cleaner of clause 1, wherein the plurality of suction members comprises at least three suction members.
5. The surface cleaner of clause 1, wherein the plurality of suction members comprises at least one inward suction member positioned at an inward portion of the base relative to the at least one cleaning member.
6. The surface cleaner of clause 1, wherein the plurality of suction members comprises at least one inward suction member positioned at an inward portion of the base relative to the at least one cleaning member and at least one outward suction member positioned at an outward portion of the base relative to the at least one cleaning member.
7. The surface cleaner of clause 1, wherein the at least one cleaning member comprises at least one brush.
8. The surface cleaner of clause 7, wherein the at least one brush is rotatable.
9. The surface cleaner of clause 1, wherein the at least one cleaning member comprises a cleaning pad.

### Clause Set C

1. A robotic surface cleaner comprising:
   a mobile base that is movable along an underneath surface;
   at least one cleaning member positioned on the underside of the base; and
   a central suction member attached to a central portion of the base, the central suction member being adjustable between an anchor condition and a release condition, in the anchor condition the central suction member engages the surface underneath the base and a suction force is applied to secure the central suction member to the surface and maintain the cleaning member in position to contact the surface, and in the release condition the central suction member is disengaged from the surface;
   wherein the base is rotatable about a central rotation axis defined by the central suction member while the central suction members is maintained in the anchor condition.
2. The surface cleaner of clause 1, wherein the surface cleaner is operable to adjust the suction force applied by the central suction member while in the anchor condition.
3. The surface cleaner of clause 1, further comprising at least one additional outward suction member positioned at an outward portion of the base relative to the at least one cleaning member.
4. The surface cleaner of clause 1, further comprising at least one periphery suction member positioned at the periphery of the base.
5. The surface cleaner of clause 4, wherein the at least one periphery suction member comprises at least 3 periphery suction members.
6. The surface cleaner of clause 1, further comprising at least one additional inward suction member positioned at an inward portion of the base relative to the at least one cleaning member.
7. The surface cleaner of clause 1, further comprising at least one inward suction member positioned at an inward portion of the base relative to the at least one cleaning member and at least one outward suction member positioned at an outward portion of the base relative to the at least one cleaning member.
8. The surface cleaner of clause 1, wherein the at least one cleaning member comprises at least one brush.
9. The surface cleaner of clause 8, wherein the at least one brush is rotatable.
10. The surface cleaner of clause 1, wherein the at least one cleaning member comprises a cleaning pad.

### Clause Set D

1. A surface cleaning method comprising:
   operating a surface cleaner to clean a surface while the surface cleaner is maintained in a first position overlying the surface by at least one suction member;
   moving the surface cleaner to a second position overlying the surface; and
   operating the surface cleaner to clean the surface while the surface cleaner is maintained in the second position by the at least one suction member.
2. The method of clause 1, further comprising:
   positioning the surface cleaner in the first position;
   securing the surface cleaner in the first position by using the at least one suction member to engage a surface underneath the surface cleaner and to apply a suction force to secure the at least one suction member to the surface.
3. The method of clause 2, further comprising disengaging the at least one suction member from the surface prior to moving the surface cleaner to the second position.
4. The method of clause 1, wherein operating the surface cleaner to clean the surface comprises dispensing cleaning fluid onto the surface.
5. The method of clause 1, wherein operating the surface cleaner to clean the surface comprises operating a surface cleaning member to agitate the surface.
6. The method of clause 1, further comprising rotating the surface cleaner while the surface cleaner is maintained in the first position.
7. The method of clause 1, wherein at least one of the suction members remains secured to the surface while the surface cleaner is moved to the second position.
8. The method of clause 1, further comprising repeating, for an entire surface area to be cleaned, the steps of:
   moving the surface cleaner to an additional position overlying the surface; and
   operating the surface cleaner to clean the surface while the surface cleaner is maintained in the additional position by the at least one suction member.
9. The method of clause 1, further comprising:
   identifying the second position as an anchor position within a surface area to be cleaned; and
   moving the surface cleaner to the second position in response to identifying the anchor position.
10. The method of clause 1, further comprising identifying an anchor position by:
   detecting an unclean surface region; and
   defining the anchor position such that the surface cleaner overlies at least a portion of the unclean surface region when moved to the anchor position.

### Clause Set E

1. A robotic surface cleaner comprising:
   a mobile base that is movable along an underneath surface;
   at least one cleaning member positioned on the underside of the base; and
   at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface;
   wherein the surface cleaner is operable in an anchored cleaning mode in which a translatable cleaning member of the at least one cleaning member is movable relative to the surface to thereby clean the surface while at least one of the suction members is secured to the surface in the anchor condition.
2. The robotic surface cleaner of clause 1, wherein:
   the at least one suction member includes a first set of suction members and a second set of suction members; and
   when the surface cleaner is in the anchored cleaning mode the second set of suction members are in the release condition and are movable relative to the surface while the first set of suction members are secured to the surface in the anchor condition.
3. The robotic surface cleaner of clause 2, wherein:
   the surface cleaner is operable in a repositioning mode; and
   when the surface cleaner is in the repositioning mode the second set of suction members are secured to the surface in the anchor condition and the first set of suction members are in the release condition and are movable relative to the surface to reposition the first set of suction members.
4. The robotic surface cleaner of clause 3, wherein:
   the surface cleaner is configured to operate sequentially in the anchor cleaning mode and the repositioning mode.
5. The robotic surface cleaner of clause 4, wherein the surface cleaner is configured to iteratively repeat the anchor cleaning mode and the repositioning mode while cleaning a surface region.
6. The robotic surface cleaner of clause 1, wherein
   the translatable cleaning member is in a fixed position on the underside of the mobile base, and in the anchored cleaning mode the cleaning member is translated by motion of at least a portion of the mobile base along the surface.
7. The robotic surface cleaner of clause 6, wherein each suction member is attached to the base by an extendable arm, wherein the extendable arm is operable to extend in response to motion of the base while the suction member is in the anchor condition.
8. The robotic surface cleaner of clause 1, wherein when the surface apparatus is in the anchored cleaning mode:
   the mobile base is maintained in a fixed position by the at least one of the suction members secured to the surface in the anchor condition; and
   the cleaning member is movable relative to the mobile base.
9. The robotic surface cleaner of clause 8 wherein:
   the at least one suction member includes a first set of suction members and a second set of suction members; and
   when the surface cleaner is in the anchored cleaning mode the second set of suction members are in the release condition and the first set of suction members are secured to the surface in the anchor condition.
10. The robotic surface cleaner of clause 8 wherein:
   the at least one suction member includes a first set of suction members and a second set of suction members; and
   when the surface cleaner is in the anchored cleaning mode the second set of suction members and the first set of suction members are secured to the surface in the anchor condition.
11. The robotic surface cleaner of clause 2, wherein each set of suction members comprises at least two suction members.
12. The robotic surface cleaner of clause 9, wherein each set of suction members comprises at least two suction members.
13. The robotic surface cleaner of clause 10, wherein each set of suction members comprises at least two suction members.

### Clause Set F

1. A surface cleaning method comprising:
   operating a surface cleaner to initially clean a first region of a surface underlying the surface cleaner while the surface cleaner is at a first position overlying the first region;
   securing the surface cleaner in the first position by applying at least one suction member to the surface within the first region; and
   operating the surface cleaner to clean the first region while the surface cleaner is maintained in the first position by the at least one suction member.
2. The method of clause 1, wherein:
   initially cleaning the first region comprises cleaning an anchor section of the first region; and
   the at least one suction member is applied to the anchor section to secure the surface cleaner in the first position.
3. The method of clause 1, wherein operating a surface cleaner to initially clean the first region comprises rotating the surface cleaner while the surface cleaner is in the first position.
4. The method of clause 1, wherein the first region is initially cleaned using suction.
5. The method of clause 1, wherein the first region is initially cleaned a cleaning member of the surface cleaner.
6. The method of clause 1, further comprising:
   detecting an uneven surface portion; and
   selecting the first position to avoid positioning the surface cleaner on the uneven surface portion.
7. The method of clause 1, further comprising:
   determining that the first position overlies an uneven surface portion; and
   applying a fluid to the uneven surface portion prior to applying the at least one suction member to the surface to improve the suction force applied by the at least one suction member.
8. The method of clause 1, further comprising:
   applying a fluid to the first region prior to applying the at least one suction member to the surface to improve the suction force applied by the at least one suction member.
9. The method of clause 1, further comprising maintaining the surface cleaner in the first position using a suction motor to continuously apply a motorized suction force between the at least one suction member and the surface.
10. The method of clause 1, further comprising:
   determining that the first position overlies an uneven surface portion; and
   maintaining the surface cleaner in the first position using a suction motor to continuously apply a motorized suction force between the at least one suction member and the uneven surface portion.

### Clause Set G

1. A robotic surface cleaner comprising:
   a mobile base that is movable along an underneath surface;
   at least one cleaning member positioned on the underside of the base; and
   a controller operable to drive motion of the mobile base along the underneath surface, wherein the controller is configured to:
      receive a stain detection signal indicating an unclean surface region;
      in response to the stain detection signal, drive the mobile base to an anchor position such that the surface cleaner overlies at least a portion of the unclean surface region when moved to the anchor position; and
      operate the at least one cleaning member to clean the unclean surface region while the mobile base is in the anchor position.
2. The surface cleaner of clause 1, further comprising:
   at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface;
   wherein the controller is configured to operate the surface cleaner in a spot cleaning mode, in which at least one of the suction members is secured to the surface in the anchor condition while the at least one cleaning member is operated to clean the unclean surface region.
3. The surface cleaner of clause 1, further comprising a cleaning fluid dispenser, wherein the controller is configured to operate the cleaning fluid dispenser to dispense cleaning fluid onto the unclean surface region prior to operating the at least one cleaning member to clean the unclean surface region.
4. The surface cleaner of clause 1, further comprising a sensor operable to detect the unclean surface region and to generate the stain detection signal in response to detecting the unclean surface region.
5. The surface cleaner of clause 1, wherein the stain detection signal is received from a color sensor and/or an ultraviolet detector.
6. The surface cleaner of clause 1, wherein the stain detection signal is received from a remote computing device in communication with the controller.
7. The surface cleaner of clause 6, wherein the stain detection signal is user-generated.
8. The surface cleaner of clause 6, wherein:
   the stain detection signal is generated in response to image data captured by the remote computing device indicating the unclean surface region; and
   the stain detection signal includes stain coordinates for the unclean surface region, wherein the controller is operable to drive the mobile base to the anchor position based on the stain coordinates.
9. The surface cleaner of clause 8, wherein
   the stain coordinates are defined based on relative base coordinates indicating a relative position of a surface cleaner base station to the image data captured by the remote computing device.
10. The surface cleaner of clause 1, wherein the stain detection signal is received from a camera.

### Clause Set H

1. A robotic surface cleaner comprising:
   a mobile base that is movable along an underneath surface;
   at least one cleaning member positioned on the underside of the base;
   at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; and
   a suction member cleaning unit operable to clean each suction member while that suction member is in the release condition.
2. The surface cleaner of clause 1, wherein the suction member cleaning unit comprises a wiper operable to clean a lower surface of a corresponding suction member while that suction member is in the release condition.
3. The surface cleaner of clause 2, wherein the wiper is intermittently cleanable.
4. The surface cleaner of clause 3, wherein the wiper is cleanable at a surface cleaner base station.
5. The robotic surface cleaner of clause 1, wherein the suction member is cleanable onboard the surface cleaner.
6. The robotic surface cleaner of clause 5, wherein the suction member is cleanable while the surface cleaner is operational.
7. The robotic surface cleaner of clause 1, wherein the suction member is cleanable at a surface cleaner base station.
8. The surface cleaner of clause 1, wherein the suction member cleaning unit comprises a cloth member operable to clean a lower surface of a corresponding suction member by travelling along the lower surface while that suction member is in the release condition.
9. The surface cleaner of clause 8, wherein the cloth member is provided by a windable roll of cloth.
10. The surface cleaner of clause 8, wherein the cloth member is provided by a continuous loop of cloth.
11. The surface cleaner of clause 10, wherein cloth portions of the loop of cloth are cleaned after travelling along the lower surface of the corresponding suction member.

### Clause Set I

1. A robotic surface cleaner comprising:
   a mobile base that is movable along an underneath surface;
   at least one cleaning member positioned on the underside of the base;
   at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; and
   a suction member cleaning unit operable to clean each suction member while that suction member is in the release condition, wherein the suction member cleaning unit comprises a roll of cleaning material.
2. The robotic surface cleaner of clause 1, wherein the roll of cleaning material is reusable.
3. The robotic surface cleaner of clause 1, wherein the roll of cleaning material is cleanable onboard the surface cleaner.
4. The robotic surface cleaner of clause 3, wherein the roll of cleaning material is cleanable while the surface cleaner is operational.
5. The robotic surface cleaner of clause 1, wherein the roll of cleaning material is cleanable at a surface cleaner base station.
6. The robotic surface cleaner of clause 1, wherein the roll of cleaning material is a roll of disposable cleaning material.

### Clause Set J

1. A robotic surface cleaner comprising:
   a mobile base that is movable along an underneath surface;
   at least one cleaning member positioned on the underside of the base;
   at least one suction member attached to the base, each suction member being adjustable between an anchor condition and a release condition, in the anchor condition the suction member engages the surface underneath the base and a suction force is applied to secure the suction member to the surface and maintain the cleaning member in position to contact the surface, and in the release condition the suction member is disengaged from the surface; and
   at least one inflatable cuff surrounding at least one carpet cleaning suction member;
   wherein the surface cleaner is operable in a carpet cleaning mode in which the inflatable cuff is in an inflated condition and the at least one carpet cleaning suction member is in the anchor condition.
2. The robotic surface cleaner of clause 1, further comprising a suction motor coupled to the at least one carpet cleaning suction member, wherein the suction motor is operable to establish the suction force between the at least one carpet cleaning suction member and the surface when the surface cleaner is in the carpet cleaning mode.

### Clause Set K

1. A robotic surface cleaner comprising:
   a mobile base that is movable along an underneath surface; and
   a disinfectant member comprising an ultraviolet light source operable to disinfect the surface by directing ultraviolet light at the surface.
2. The robotic surface cleaner of clause 1, further comprising:
   a dirt inlet fluidly coupled to an airflow pathway; and
   a motor and fan assembly coupled to the airflow pathway.
3. The robotic surface cleaner of clause 1, further comprising at least one cleaning member attached to the base, the cleaning member operable to clean the surface underneath the base.
4. The robotic surface cleaner of clause 3, wherein the at least one cleaning member comprises at least one brush.
5. The surface cleaner of clause 4, wherein the at least one brush is rotatable.
6. The surface cleaner of clause 3, wherein the at least one cleaning member comprises a cleaning pad.
7. The surface cleaner of clause 1, further comprising a cleaning fluid dispenser operable to dispense cleaning fluid onto the surface.

1. A robotic surface cleaner comprising:
a mobile base that is autonomously movable along an underneath surface;
at least one cleaning member located on the underside of the base; and
at least one suction member attached to the base, each suction member being adjustable between an anchor condition and a release condition, in the anchor condition the suction member engages the surface underneath the base and a suction force secures the suction member to the surface and maintains the cleaning member in position to contact the surface, and in the release condition the mobile base is movable along the underneath surface.

2. The surface cleaner of claim 1, wherein the at least one cleaning member is located at an inward portion of the base and the at least one suction member is positioned at an outer portion of the base that is outward from the inward portion.

3. The surface cleaner of claim 1, wherein the at least one suction member comprises a plurality of suction members arranged along the periphery of the base.

4. The surface cleaner of claim 1, wherein the at least one suction member comprises at least three suction members.

5. The surface cleaner of claim 1, wherein each suction member is individually controllable to adjust the condition of the suction member.

6. The suction cleaning apparatus of claim 5, wherein each suction member is individually controllable to adjust the suction force applied by that suction member in the anchor condition.

7. The suction cleaning apparatus of claim 1, wherein each suction member is individually controllable to adjust the suction force applied by that suction member in the anchor condition.

8. The surface cleaner of claim 1, wherein the surface cleaner is operable in an anchored cleaning mode in which the at least one cleaning member is operable to clean the surface while at least one of the suction members is secured to the surface in the anchor condition.

9. The surface cleaner of claim 1, wherein the surface cleaner is operable in a mobile cleaning mode in which at least one cleaning member is operable to clean the surface while the base moves along the surface.

10. The surface cleaner of claim 9, wherein the motion of the cleaning member drives the base along the surface.

11. The surface cleaner of claim 9, further comprising at least one floor engaging member mounted to the underside of the base, wherein the floor engaging member is operable to drive motion of the base along the surface.

12. The surface cleaner of claim 9, wherein at least one of the suction members is maintained in the release condition while the surface cleaner is operating in the mobile cleaning mode.

13. The surface cleaner of claim 9, wherein at least one of the suction members is maintained in the anchor condition while the surface cleaner is operating in the mobile cleaning mode.

14. The surface cleaner of claim 1, further comprising at least one floor engaging member mounted to the underside of the base, wherein the floor engaging member is operable to provide a driving force for the base.

15. The surface cleaner of claim 1, wherein the at least one cleaning member comprises at least one brush.

16. The surface cleaner of claim 15, wherein the at least one brush is rotatable.

17. The surface cleaner of claim 1, wherein the at least one cleaning member comprises a cleaning pad.

18. The surface cleaner of claim 1, further comprising a suction motor operable to establish the suction force between at least one of the suction members and the surface.

19. The surface cleaner of claim 18, further comprising:
a dirt inlet fluidly coupled to an airflow pathway; and
a first fan provided in the airflow pathway;
wherein the suction motor is drivingly connected to the first fan.

20. The surface cleaner of claim 18, further comprising an inflatable cuff surrounding a carpet cleaning suction member of the at least one suction member, wherein the surface cleaner is operable in a carpet cleaning mode in which the inflatable cuff is in an inflated condition and the at least one carpet cleaning suction member is in the anchor condition.
